(19) United States
(12) Patent Application Publication
(10) Pub. No.: US 2026/0222139 A1
(43) Pub. Date: Jul. 30, 2026

(54) METHODS, ARCHITECTURES, APPARATUSES AND SYSTEMS FOR REDUCED REFERENCE SIGNAL OVERHEAD IN NEAR FIELD

(71) Applicant: InterDigital Patent Holdings, Inc., Wilmington, DE (US)

(72) Inventors: Chia-Hung Wei, Chesterbrook, PA (US); Patrick Svedman, Stockholm (SE); Afshin Haghighat, Ile-Bizard (CA); Ravikumar Pragada, Warrington, PA (US); Loic Canonne-Velasquez, Dorval (CA); Allan Yingming Tsai, Boonton, NJ (US); Salah Elhoushy, LaSalle (CA); Yifan Li, Conshohocken, PA (US)

(21) Appl. No.: 19/041,451

(22) Filed: Jan. 30, 2025

(51) Int. Cl. H04L 5/00; H04W 4/80; H04W 24/08; H04W 24/10; H04W 72/232

(52) U.S. Cl. CPC H04L 5/0048; H04L 5/0094; H04W 24/08; H04W 24/10; H04W 72/232; H04W 4/80

(57) ABSTRACT

Methods, apparatuses, devices, and/or computer program products for reduced reference signal (RS) overhead are described. A method may include receiving configuration information indicating an association between a transmission configuration indication (TCI) state and first, second and third reference signals (RSS). The method may include receiving an indication to switch the TCI state to the first TCI status and thereby determining to receive first source RS. The method may include receiving an indication to switch the TCI state to the second TCI status and thereby determining to receive the second and the third source RSs. The method may also include receiving a downlink transmission based on the activated RSs.

### FIELD

Example embodiments described in the present disclosure are generally directed to the fields of communications, software and encoding, including, for example, to methods, architectures, apparatuses, systems related to reducing reference signal overhead, for example, in near field (NF).

### BACKGROUND

A user equipment (UE) or wireless transmit/receive unit (WTRU) can be configured with a reference signal (RS) to be monitored for a variety of purposes including beam management. For example, in the Transmission Configuration Indication (TCI) framework for beam management in 3GPP NR wireless communication system, a UE can be indicated with a TCI state to be applied for a downlink channel reception and/or an uplink channel transmission.

### SUMMARY

An embodiment may be directed to a wireless transmit/receive unit (WTRU), which may include circuitry, including any of a processor and/or transceiver. The circuitry is configured to receive configuration information indicating a transmission configuration indication (TCI) state, wherein the TCI state is associated with (1) a first source reference signal associated with a first quasi co-location (QCL) type for a first TCI status, (2) a second source reference signal associated with the first QCL type for a second TCI status, and (3) a third source reference signal associated with a second QCL type. The circuitry may be configured to receive first information indicating to switch the TCI state to the first TCI status and, based on the first information, determine to receive the first source reference signal. The circuitry may be configured to perform measurements on the first source reference signal, receive second information indicating to switch the TCI state to the second TCI status and, based on the second information, determine to receive the second source reference signal and/or the third source reference signal. The circuitry may be configured to receive a downlink transmission based on the second source reference signal and/or the third source reference signal.

An embodiment may be directed to a method, which may be implemented by a wireless transmit/receive unit (WTRU). The method may include receiving configuration information indicating a transmission configuration indication (TCI) state, wherein the TCI state is associated with (1) a first source reference signal associated with a first quasi co-location (QCL) type for a first TCI status, (2) a second source reference signal associated with the first QCL type for a second TCI status, and (3) a third source reference signal associated with a second QCL type. The method may include receiving first information indicating to switch the TCI state to the first TCI status and, based on the first information, determining to receive the first source reference signal. The method may include performing measurements on the first source reference signal, receiving second information indicating to switch the TCI state to the second TCI status and, based on the second information, determining to receive the second source reference signal and/or the third source reference signal. The method may also include receiving a downlink transmission based on the second source reference signal and/or the third source reference signal.

In an embodiment, the configuration information comprises time-domain property configuration information indicating the first source reference signal, the second source reference signal, and the third source reference signal are of a semi-persistent type.

In an embodiment, the first QCL type comprises QCL type D and the second QCL type comprises QCL type A.

In an embodiment, the first TCI status comprises a semi-active status and the second TCI status comprises an active status.

In an embodiment, the third source reference signal is associated with the first QCL type for the second TCI status.

In an embodiment, the WTRU may report, to a network node, a result of the measurements performed on the first source reference signal.

In an embodiment, the first information is, or is included in, a medium access control (MAC) control element (CE).

In an embodiment, the second information is, or is included in, a first downlink control information (DCI).

In an embodiment, the downlink transmission comprises a physical downlink shared channel (PDSCH) transmission. In an embodiment, the WTRU is configured to receive third information indicating a physical downlink shared channel (PDSCH) reception based on the TCI state, and to receive the physical downlink shared channel (PDSCH) transmission based on the second source reference signal and the third source reference signal.

In an embodiment, the configuration information comprises an associated TCI status indicator (ATSI) to indicate that the first, second and third source reference signals are associated with any of the first TCI status and the second TCI status.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example diagram of TCI state and source RS configuration, according to some embodiments;

FIG. 3 illustrates a flow diagram of a method 300 for source RS transmission determination, according to certain embodiments; and

FIG. 4A illustrates an example of a configuration structure, according to some embodiments;

FIG. 4B illustrates another example of a configuration structure, according to some embodiments;

FIG. 5 illustrates an example of a port pattern configuration, according to some embodiments;

FIG. 6 illustrates an example association between TCI state (configuration) and source RS trigger states, according to some embodiments;

FIG. 7 illustrates an example configuration of Source RS level approach source RS trigger state, according to an embodiment;

FIG. 8 illustrates an example configuration of TCI state level approach source RS trigger state, according to certain embodiments;

FIG. 9 illustrates an example of source RS (de)activation according to TCI status, in accordance with some embodiments;

FIG. 10A illustrates a signaling diagram, according to an embodiment;

FIG. 10B illustrates a signaling diagram, according to an embodiment;

FIG. 10C illustrates a signaling diagram, according to an embodiment;

FIG. 11 illustrates an example diagram depicting first and second TCI statuses showing corresponding RS on/off, according to certain embodiments;

FIG. 12 illustrates an example of TCI state configuration with different periodicity, according to an embodiment;

FIG. 13 illustrates an example of RS triggering states configuration, according to an embodiment;

FIG. 14A illustrates a flow diagram of a method, according to an embodiment; and

FIG. 14B illustrates a flow diagram of a method, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

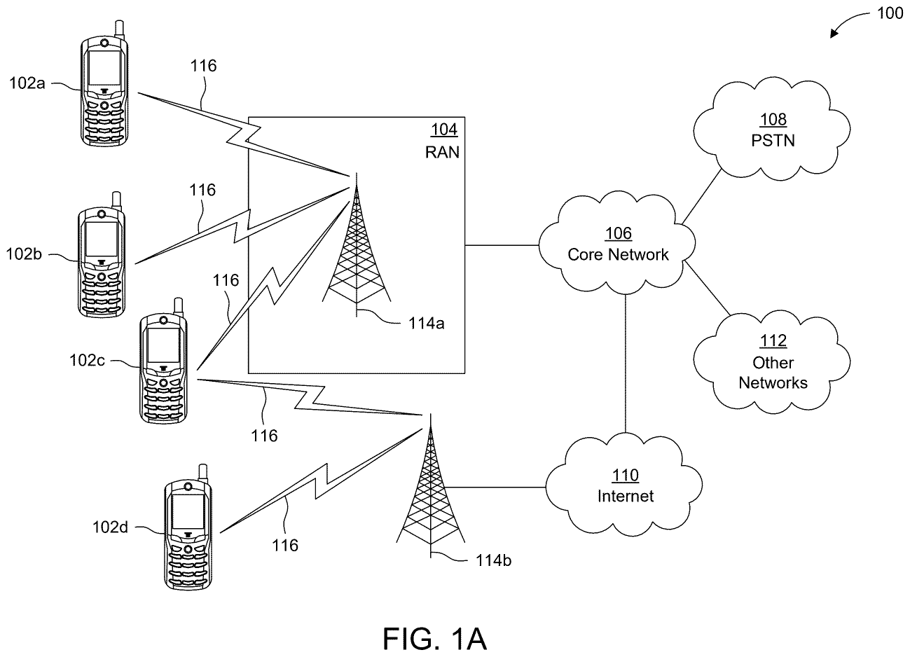

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “serving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

In legacy systems, a WTRU can be configured with a reference signal (RS) to be monitored for variety of purposes including beam management. For example, in a Transmission Configuration Indication (TCI) framework for beam management in 3GPP NR wireless communication system, a WTRU can be indicated with a TCI state to be applied for a downlink channel reception and/or an uplink channel transmission. Each TCI state may indicate one or two source RS to be applied for different types of quasi-co-location (QCL) property (e.g., parameter) estimation. The source RS may be configured as any one of periodic, semi-persistent, or aperiodic type.

The WTRU may be pre-configured, e.g., by the gNB via radio resource control (RRC), with multiple TCI states as candidates. A subset of the pre-configured TCI states may be activated by the gNB, e.g., via a medium access control (MAC) control element (CE). A TCI state, from among the TCI states that have been activated by the MAC CE, may be indicated by the gNB, via DCI, to be applied by the WTRU for downlink channel reception and/or uplink channel transmission. For TCI state(s) which have been activated (e.g., by the MAC CE), the WTRU may monitor the corresponding source RS for QCL property estimation, and to perform the corresponding downlink channel reception and/or uplink channel transmission.

For purposes of QCL properties (e.g., Doppler shift, doppler spread, delay shift, delay spread) estimation on channel(s) transmitted through a beam (e.g., NF/spot beam), a gNB may transmit individual source RSs corresponding to each TCI state for different (e.g., NF/spot) beams. A TCI state may indicate a source RS for QCL type A and a source RS for QCL type D. The source RS for QCL type A may be different from the source RS for QCL type D. A channel state information reference signal (CSI-RS) can be configured with different time-domain properties, e.g., Periodic (P), Aperiodic (AP) or Semi-persistent (SP). The activation and deactivation of SP CSI-RS can be done via a dedicated DL MAC CE.

To support that the UE has source RSs for accurate QCL property estimation on spot beams (i.e., NF beams), the network (e.g., a gNB) needs to transmit a large amount of spot beam specific source RSs for corresponding QCL estimation. Therefore, a problem arises as to how to enable the network (e.g., gNB) to efficiently turn off transmission of source RSs that are currently not used for QCL property estimation. In other words, the problem arises as to how to enable the network to efficiently manage the source RSs transmission to assist a WTRU in having source RSs for QCL property estimation.

In addition, periodic RS may be used for multiple purposes such as mobility, initial access (e.g., SSB), beam management, QCL type-D source RS, etc. Different purposes may impose different requirements on RS transmission periodicity. A shorter RS transmission periodicity (i.e., more frequent transmission) may be required for QCL type-D estimation when the corresponding TCI state is semi-activated or activated. However, always using this short periodicity incurs unnecessary RS overhead. Therefore, a problem arises as to how the overhead for periodic RS transmission can be reduced, without sacrificing QCL estimation performance, e.g., for a TCI state in semi-active status.

As will be discussed in more detail in the following, according to some embodiments, RS transmission for a TCI (e.g., NF TCI) state is activated and/or triggered as a function of TCI state status of the TCI (e.g., NF TCI) state, QCL type of RS corresponding to the TCI (e.g., NF TCI) state and/or time-domain properties (i.e., AP, SP, or P) of RS(s) corresponding to the TCI state (e.g., NF TCI state). For example, in an embodiment, a source RS of a TCI state can be pre-configured with multiple time-domain properties. Then, the WTRU may be further indicated to apply a sub-set of the multiple time-domain properties dynamically. For example, in an embodiment, a WTRU may determine the time domain property, QCL type, and port pattern of the source RS transmission based on the corresponding TCI state status (switching). Further, in an embodiment, in order to dynamically indicate to apply different source RS transmission configurations, each combination of multiple source RS corresponding configurations may be grouped into multiple source RS trigger states.

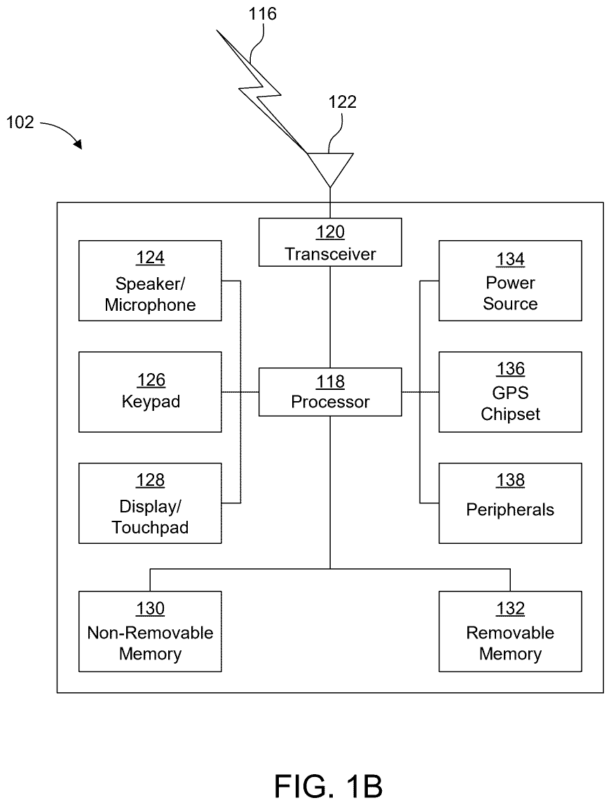

FIG. 2 illustrates an example diagram of TCI state and source RS configuration, according to some embodiments. As illustrated in the example of FIG. 2, the WTRU may need to receive both the QCL-type A source RS (e.g., transmitted via NF spot beam) and the QCL-type D source RS (e.g., transmitted via FF beam) in an activated TCI state (e.g., TCI state 2 as illustrated in the example of FIG. 2). For a semi-activated TCI state (e.g., TCI state 4 as illustrated in the example of FIG. 2), the WTRU may need to receive the QCL-type D source RS, but not the QCL-type A RS. For a deactivated TCI state (e.g., TCI state k), the WTRU might not need to receive any of the source RS.

For SP CSI-RSs as QCL-type A and QCL-type D source RSs, an embodiment may be configured to connect the SP activation or deactivation with the corresponding TCI state semi-activation, activation, and/or deactivation.

According to certain embodiments, RS transmission for a TCI state (e.g., NF TCI state) may be activated and/or triggered as a function of any one or more of the TCI state status of the TCI state (e.g., NF TCI state), QCL type of RS corresponding to the (NF) TCI state, and/or time-domain properties (e.g., AP/SP/P) of RS(s) corresponding to the (NF) TCI state. As an example, according to some embodiments, the SP source RS of a TCI state is determined to activate and deactivate based on information (e.g., in a DCI or MAC CE) for indicating the status switching of the TCI state.

According to certain embodiments, a WTRU (e.g., WTRU 102 discussed above) may be configured to receive configuration information (e.g., RRC configuration) from a network (e.g., a gNB or base station). The configuration information may include or may indicate a TCI state that is associated with (1) a first source RS for a first QCL type (e.g., QCL type D) for a first TCI status (e.g., semi-active status), (2) a second source RS for the first QCL type for a second TCI status (e.g., active status and, e.g., with the second source RS having a shorter periodicity than the first source RS), and (3) a third source RS for a second QCL type (e.g., QCL type A). In an embodiment, the configuration information may further include or indicate a time-domain property configuration indicating that the first, second and third source RSs are of semi-persistent type.

In some embodiments, the WTRU may be configured to receive, from the network (e.g., gNB or base station), a transmission, such as a MAC CE, indicating to switching the TCI state to the first TCI status. According to an embodiment, the WTRU may determine that the first source RS is activated based on the MAC CE. The WTRU may perform measurement(s) on the first source RS and may report the measurement result to the network (e.g., gNB or base station).

According to certain embodiments, the WTRU may receive, from the network (e.g., gNB or base station), information, such as a DCI (e.g., a first DCI), indicating to switch the TCI state to the second TCI status. Based on the first DCI, the WTRU may determine that the first source RS is deactivated and that the second source and third source RS are activated.

In some embodiments, the WTRU may receive information, such as a DCI (e.g., a second DCI), indicating a downlink reception (e.g., PDSCH) based on the TCI state. The WTRU may then receive the downlink transmission (e.g., PDSCH transmission) based on the second source RS and the third source RS.

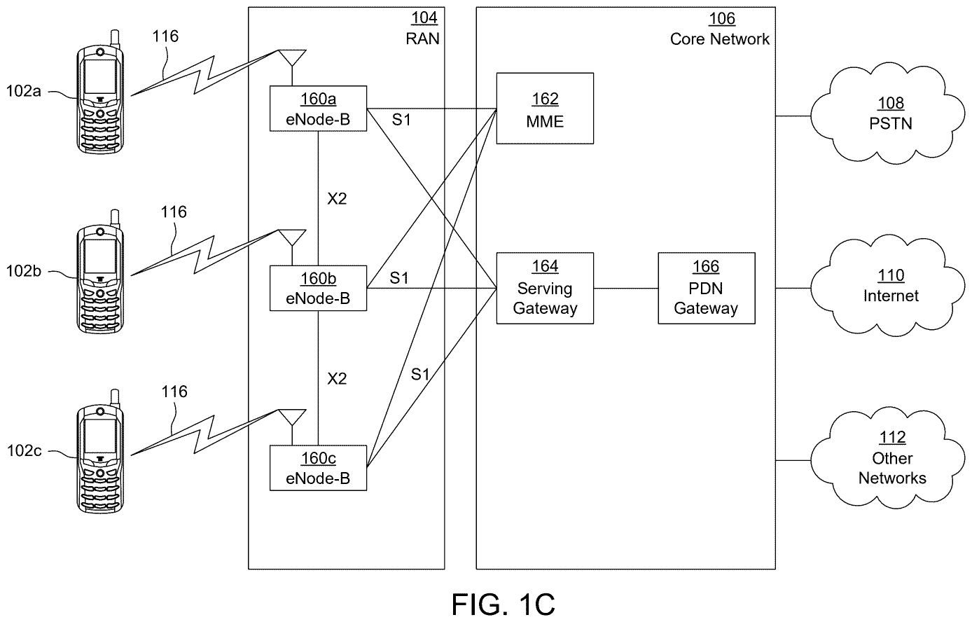

FIG. 3 illustrates a flow diagram of a method 300 for source RS transmission determination, according to certain embodiments. In some embodiments, the method may be performed or implemented by a WTRU, such as WTRU 102 discussed above. As illustrated in the example of FIG. 3, the method 300 may include, at 305, receiving information that indicates correspondence between TCI state and source RS configuration (e.g., as discussed above, WTRU may receive information indicating a TCI state that is associated with a first source RS for a first QCL type for a first TCI status, a second source RS for the first QCL type for a second TCI status, and a third source RS for a second QCL type). The method 300 may include, at 310, receiving a TCI status switching indicator (e.g., via MAC CE or DCI as discussed above). The method 300 may include, at 315, determining which source RS is activated and to be monitored (e.g., based on the received status switching indicator). At 320, the method 300 may include receiving a downlink transmission (e.g., PDSCH transmission) based on the source RS monitoring (e.g., based on the activated source RS(s)). Additional details regarding the method 300 are discussed in the following.

As will be discussed in more detail below, certain embodiments provide a benefit of reducing overhead of RS for QCL type-A (e.g., NF spot beam) and QCL type-D of a TCI state when the TCI state is semi-activated. Some embodiments provide the benefit of avoiding the signaling overhead associated with (de)activation RS transmission, since the (de)activation RS transmission is linked to corresponding TCI state status switching. In addition, certain embodiments advantageously reduce the RS activation delay.

As used herein, Far-Field (FF) Beamforming may refer to Multi-antenna transmission/reception scheme that focuses transmitted/received energy to/from an angular direction in the far field. A FF beam may refer to the beam, e.g., in the FF, applying FF beamforming.

As introduced above, gNB is used to refer to a network node. The node may, for instance, configure, control, and communicate with a WTRU. The node may terminate a communication protocol with the WTRU. Even though this term is used in 5G systems, embodiments herein are not limited to 5G NR.

As used herein, Near-Field (NF) Beam-focusing may refer to multi-antenna transmission/reception scheme that focuses transmitted/received energy to/from an angular direction and focus distance in the near-field.

An NF beam is the beam, e.g., in the NF, applying NF Beam-focusing; an NF beam may also be called a “spot beam”.

A TCI state indicates which (source) RS should be applied by a WTRU for a specific type of QCL property or parameter estimation for a target channel/RS reception/transmission.

A TCI status may refer to a logical status of a TCI state which may be indicated by the network (e.g., gNB or base station) and/or determined by the WTRU. The TCI status may be used by the WTRU for determining RS monitoring and for TCI state indicator interpretation.

A source RS is a (set of) RS associated with a TCI state, where the RS may for example be a CSI-RS, SSB, SRS, DMRS, etc. The (set of) RS is assumed to be QCLed with one or more target RS. The one or more target RS may be associated with a target channel, e.g., PDCCH, PDSCH, PUCCH, PUSCH, etc. The target channel is a channel that, or the associated target RS, has been indicated to be received/transmitted based on the TCI state. A source RS may be periodic, in which case an occasion to receive the source RS occurs periodically. A source RS may be semi-persistent, in which case an occasion to receive the source RS occurs periodically as long as the source RS is activated. A source RS may be aperiodic, in which case an occasion to receive the source RS occurs aperiodically, e.g., following a trigger received by the UE. It is noted that, in the present disclosure, a WTRU being configured with a source RS via a source RS configuration may be interpreted as the WTRU being configured with a set of source RS via the source RS configuration.

Source RS monitoring may correspond to WTRU reception of one or more occasions of the source RS, or a subset of a set of source RS. In some cases, e.g., during a time period, or for relatively infrequent occasions, the WTRU may receive the source RS on each occasion. In some cases, e.g., during a time period, or for relatively frequent occasions, the WTRU may receive the source RS on a first subset of the occasions but skips source RS reception in a second subset of the occasions. For example, the WTRU may monitor source RS to meet an application delay requirement for a TCI state that is in active status and that comprises the source RS. The WTRU may need to monitor source RS of the TCI state for particular QCL properties estimation (e.g., QCL type A property and/or QCL type D property). The application delay may be defined as the time between the WTRU being indicated to apply the TCI state for a downlink channel reception, and the time the UE is ready to apply the TCI state for the downlink channel reception.

The QCL-A property (or QCL type A property) may include one or more of Doppler shift, Doppler spread, Average delay and/or delay spread.

The QCL-D property (or QCL type D property) may include spatial parameters, e.g., for reception. In one example, the spatial parameter corresponds to a spatial domain filter, such as a spatial reception filter and/or a spatial transmission filter. In one example, the spatial parameter corresponds to a WTRU beam, e.g., a WTRU receive beam and/or a WTRU transmit beam.

TCI state application delay may refer to a time interval between the WTRU receiving a command to apply an activated TCI and the WTRU being ready to apply the indicated TCI state. It is also called Beam Application Time (BAT) application time of the beam indication or can be called TCI state switching delay.

Active status may be referred to herein as a first TCI status of a TCI state. A TCI state in active status may be indicated to apply for downlink RS/channel reception and/or uplink RS/channel transmission. After a WTRU receiving a TCI state indicator indicating an active TCI state, the WTRU should be able to apply the active TCI state within an TCI state application delay. The status may also be called activated status.

De-active status may be referred to herein as a second TCI status. A TCI state in de-active status can typically perform RS/channel reception and/or uplink RS/channel transmission. That is, a WTRU does not expect the de-active TCI state be indicated to apply for any downlink RS/channel reception and/or uplink RS/channel transmission. The status may also be called deactivated status.

Semi-active status may be referred to herein as a third TCI status of a TCI state. A TCI status switching delay for a TCI state from semi-active to active status may be shorter than from de-active to active. The status may also be called a semi-activated status.

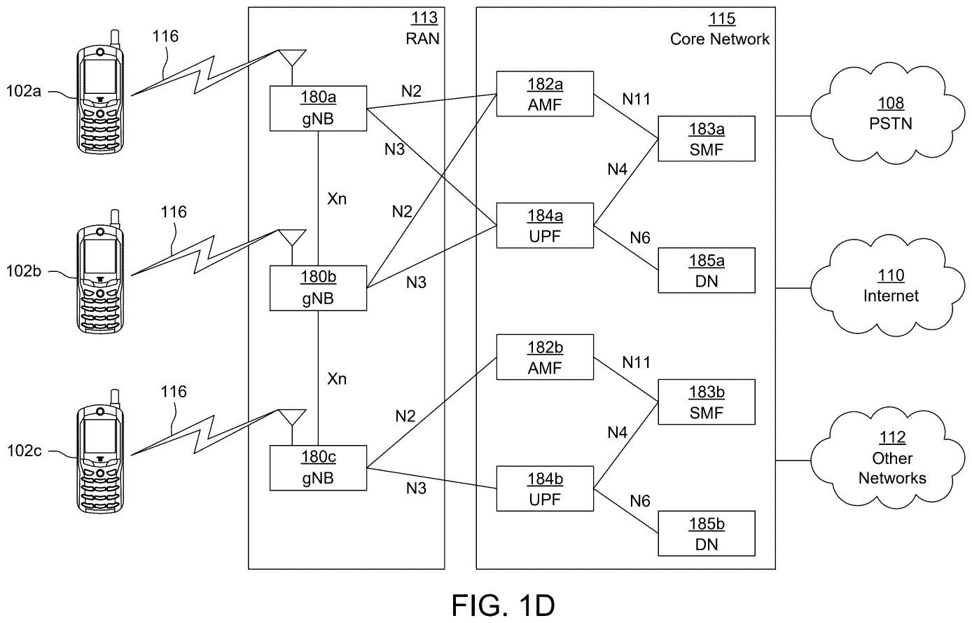

Some embodiments may include a configuration of time-domain property of RS (e.g., receiving a configuration associated with a time-domain property of RS). FIG. 4A illustrates an example of a configuration structure, according to some embodiments. As illustrated in FIG. 4A, a WTRU may receive, a downlink message (e.g., RRC message), with one ore more of TCI state(s) via one or more TCI state configuration(s) 405. That is, a TCI state configuration (i.e., TCI state config 405) configures a WTRU with a TCI state. It is noted that, in certain embodiments described herein, a TCI state configuration which configures a TCI state may be referred to as the TCI state configuration of the TCI state.

As illustrated in FIG. 4A, a TCI state configuration 405 of a TCI state may contain a TCI state ID indicator 407 associated with the TCI state. That is, the TCI state ID 407 may be applied for identifying the TCI state. The TCI state configuration 405 may also contain one or multiple QCL configuration(s) 409. A QCL configuration 409 may configure a WTRU with at least one type of QCL related parameters to be applied for the TCI state.

A QCL configuration may contain one or more of source RS configurations(s) 411 and one or more of QCL type indicator(s) 413. A source RS configuration 411 configures a WTRU with at least a source RS 415. The source RS configuration 411 configures a WTRU with a time-domain property 417, Associated TCI Status Indicator (ATSI) 419, and/or port pattern configuration 421.

A QCL type indicator 413 indicates, to a WTRU, a particular QCL type property. Each of the one or more of source RS configuration(s) 411 is associated with at least one of the one or more of QCL type indicator(s) 413. A source RS configured by a source RS configuration 411 is associated with at least one type of QCL property indicated by at least one QCL type indicator 413 associated with the source RS configuration 411. That is, a source RS is configured to be applied for at least one particular QCL type property estimation, wherein the particular QCL type is indicated by the corresponding QCL type indicator 413.

QCL property estimation requirements for a TCI state may be different for different TCI statuses. For example, to meet a TCI state application delay (e.g., an integer number of symbols) for a TCI state in active status, a source RS of the TCI state may need to be tracked properly. That is, the TCI state is in active status, the WTRU needs to (e.g., periodically) monitor the source RS of the TCI state to maintain a sufficiently accurate estimate of the corresponding QCL property. By monitoring the source RS sufficiently frequently, the WTRU can apply the TCI state in the TCI state application delay after receiving an indicator indicating to apply the TCI state.

However, if the TCI state is in the semi-active status, the WTRU may just need to monitor the source RS with less intensity since the delay requirement for the TCI state to be applied is looser than the TCI state application delay. A TCI state needs to be switched to active status before being applied or indicated to be applied. However, the switching delay requirement for the switching from semi-active to active status is expected to be looser (i.e., longer) than the TCI state application delay. In other words, the UE may use less effort on tracking, e.g., receive and process less frequently, the source RS of the TCI state in semi-active status than the source RS of the TCI state in active status.

For example, the WTRU may monitor the source RS with less frequency if the TCI state is in semi-active status. In other words, the network (e.g., gNB) may transmit the source RS less frequently for the TCI state in semi-active status than in active status.

For example, the UE may monitor different source RSs when the TCI state is in different TCI statuses. In other words, the network (e.g., gNB) may transmit a different RS for the TCI state when the TCI state is in a different TCI status.

In some embodiments, multiple source RS may be configured for a same type of QCL. A WTRU may be configured with multiple source RS for a TCI state. The WTRU may select and/or monitor one of the multiple source RSs based on the TCI status. For example, one source RS for semi-active status, and another source RS for active status.

In some embodiments, a source reference signal 415 configured by a source reference signal configuration 411 being determined as activated (or deactivated) by a WTRU may be interpreted as the WTRU determining the source reference signal 415 is transmitted (or not transmitted) by the network (e.g., gNB). In further embodiments, a source reference signal 415 configured by a source reference signal configuration 411 being determined as activated (or deactivated) by a WTRU may be interpreted as the WTRU determining the source reference signal 415 is transmitted (not transmitted) by the network (e.g., gNB) on radio resources which are configured by the source RS configuration 411. It is noted that, from the network (e.g., gNB) perspective, the source reference signal 415 may be transmitted even if the source reference signal 415 is determined as not transmitted by the WTRU. The determination of the source reference signal 415 may be based on either an ATSI associated with the source reference signal configuration 411 and/or a TCI status of a TCI state configured by TCI state configuration 405 which is associated with the source reference signal configuration 411.

In some embodiments, a source reference signal 415 configured by a source reference signal configuration 411 being determined as activated (or deactivated) by a WTRU may be interpreted as the WTRU determining the source reference signal configuration 411 is activated (or deactivated) by the network (e.g., gNB). The source reference signal configuration 411 may be activated (or deactivated) by the network (e.g., gNB) through any of layer 2 (e.g., MAC layer) or layer 1 signaling (e.g., PHY layer). It is noted that, from the network (e.g., gNB) perspective, the source refence signal 415 configured by the source reference signal configuration 411 may be transmitted by the network (e.g., gNB) even if the source reference signal configuration 411 is determined as deactivated by the WTRU.

In some embodiments, a source reference signal 415 configured by a source reference signal configuration 411 being determined as activated (or deactivated) by a WTRU may be interpreted as the WTRU determining the source reference signal 415 is needed (or not needed) to be received (or monitored) by the WTRU. Specifically, a source reference signal 415 configured by a source reference signal configuration 411 being determined as activated (or deactivated) by a WTRU may be interpreted as the WTRU determining the source reference signal 415 is needed (or not needed) to be received (or monitored) by the WTRU for a type of QCL property estimation which is configured by the QCL Type Indicator 413 associated with the source reference signal configuration 411.

As mentioned above, a source RS configuration may configure the WTRU with a source RS. The source RS configuration may contain an Associated TCI Status Indicator (ATSI). The ATSI indicates the WTRU that the source RS is associated with one or more of the TCI statuses.

In one embodiment, a QCL configuration of a TCI state contains a first source RS configuration and a second source RS configuration. The first source RS configuration configures a WTRU with a first source RS, and the second source RS configuration configures the WTRU with a second source RS.

According to certain embodiments, the first source RS configuration may contain a first ATSI indicating a first TCI status, and the second source RS configuration may contain a second ATSI indicating a second TCI status. For example, the first ATSI indicates the UE the first source RS is to be applied when the TCI state is in the first TCI status, and the second ATSI indicates the UE the second source RS is to be applied when the TCI state is in the second TCI status.

FIG. 4B illustrates another example of a configuration structure, according to some embodiments. In one embodiment, as depicted in the example of FIG. 4B, the ATSI may be carried by the QCL configuration. That is, a TCI state configuration may carry multiple QCL configurations. Each QCL configuration may include at least an ATSI, a source RS configuration and a QCL type indicator. The ATSI indicates, to the WTRU, the source RS configuration and the QCL type indicator are applied when the TCI state, configured by the TCI state configuration, is in a TCI status which indicated by the ATSI. For example, a TCI state configuration configures at least a first QCL configuration and a second QCL configuration. Both the first QCL configuration and the second QCL configuration may be configured for same type of QCL. That is, a first QCL type indicator carried by the first QCL configuration and a second QCL type indicator carried by the second QCL configuration may indicate a same type of QCL. However, a first ATSI carried by the first QCL configuration and a second ATSI carried by the second QCL configuration may indicate different TCI status.

According to certain embodiments, multiple source RS may be configured for the same type of QCL but with different time-domain properties. As illustrated in the examples of FIG. 4A and FIG. 4B, a source RS configuration 411 may contain a time-domain property configuration 417 for a source RS 415 configured by the source RS configuration 411. The time-domain property configuration 417 may indicate to the WTRU that the source RS 415 is either periodically transmitted, semi-persistent transmitted or aperiodic transmitted.

In one embodiment, a WTRU may be configured with a QCL configuration, for a TCI state, which contains a first source RS configuration and an associated first QCL type indicator. The QCL configuration may further contain a second source RS configuration and an associated second QCL type indicator. The first QCL type indicator and the second QCL type indicator may indicate the same type of QCL. That is, the TCI state may be configured with two source RSs (i.e., the first source RS and the second source RS) for the same type of QCL property estimation. The first source RS is configured to associate with first time-domain property configurations, and the second source RS is configured to associate with second time-domain property configurations. For example, the first time-domain property configuration indicates, to the WTRU, the first source RS is a periodic RS. And the second time-domain property configuration indicates, to the WTRU, the second source RS is a Semi-persistence RS. In some embodiments, the first source RS may further be configured to be associated with a first ATSI and the second source RS may further be configured to be associated with a second ATSI. The first ATSI may indicate a first TCI status and the second ATSI may indicate a second TCI status. The WTRU may determine that the first source RS is transmitted based on the first time-domain property when the TCI state in a first TCI status, and the WTRU may determine that the second source RS is transmitted based on the second time-domain property when the TCI state in a second TCI status.

In some embodiments, a source RS may be configured with multiple (transmission) periodicities. A source RS configuration may contain a Time-domain property configuration for a source RS configured by the source RS configuration. The time-domain property configuration may indicate, to the WTRU, one or multiple transmission periodicities and/or transmission (timing) offset (i.e., symbol offset).

A WTRU may be configured with multiple periodicities, e.g., via a time-domain property configuration, for a source RS of a TCI state. A periodicity may be associated with a TCI status. The WTRU may monitor the source RS assuming a source RS periodicity based on the TCI status. For example, one periodicity may be associated with semi-active status, and another periodicity with active status. In some cases, only a subset of the configured periodicities for an RS may be explicitly associated with a TCI status, while the remaining one or more periodicities are not explicitly associated with a TCI status. For example, a source RS may be configured with a first periodicity that is generally applicable, e.g., if the RS is not configured in a TCI state. The source RS may also be configured with a second, e.g., optional, periodicity that may be applicable only when a TCI state comprising the source RS is in an associated TCI status, e.g., active TCI status. In other words, in some embodiments, the first periodicity may be applicable when the second periodicity is not applicable.

A configured source RS periodicity may be associated with a TCI status and a QCL type. For example, the periodicity may be applicable only when a TCI state with the source RS configured with the associated QCL type is in associated TCI status. The associated QCL type may be configured or pre-defined.

A benefit of the TCI status dependent source RS periodicity is that RS periodicity adaptation without additional signalling overhead may be enabled. Based on indications of TCI status switching received by the WTRU, corresponding source RS periodicity adaptation may be enabled. It may be beneficial to use different source RS periodicities in different TCI status since the corresponding requirements may differ.

As mentioned above, a source RS configuration of a TCI state may configure a WTRU with a source RS. The source RS configuration may contain multiple time-domain property configurations each may contain an ATSI. An ATSI of a time-domain property configuration may indicates the UE the time-domain property configuration is applied when the TCI state is in the TCI status indicated/determined by the ATSI.

In one embodiment, a source RS configuration configures a UE with a source RS for a TCI state. The source RS configuration may contain a first time-domain property configuration and a second time-domain property configuration. The first time-domain property configuration configures the WTRU with a first periodicity, and the second time-domain property configuration configures the WTRU with a second periodicity. The first time-domain property configuration may contain a first ATSI. The first ATSI indicates the WTRU the first time-domain property configuration is to be applied when the TCI state is in a first TCI status. And the second time-domain property configuration may contain a second ATSI. The second ATSI indicates the WTRU the second time-domain property configuration is to be applied when the TCI state is in a second TCI status.

Certain embodiments may include a configuration of RS transmission ports. More specifically, some embodiments may include configuring transmission ports pattern for source RS of TCI states for different TCI status. As addressed in the foregoing, the number of TCI states required in near field (NF) may be significantly larger than in far field (FF), i.e., in legacy systems. That means the effort on source RS monitoring (tracking) for the WTRU is increased due to those larger amount of TCI states in NF. It also means the network (e.g., gNB) may need to transmit more source RS for those TCI states. The source RS transmission overhead may be reduced by transmitting the source RS with fewer number of ports and/or transmitting the source RS on fewer radio resources (i.e., source RS resource), e.g., time-, frequency-, and/or code-domain resources, when the source RS of a TCI state is not in active status. For example, while the TCI state is in a first, e.g., active, status, the source RS may be transmitted with a first number of ports. However, the source RS may be transmitted with a second number of ports when the TCI state is in a second, e.g., semi-active or de-active, status. The second number of ports may be less than the first number. The overhead for transmitting source RS with a smaller number of ports is expected to be lower than transmitting source RS with more ports. In other words, the WTRU may determine a source RS of a TCI state is transmitted with a number of ports based on at least the TCI state status. In other words, the source RS will be transmitted with more ports in activate status. The intention for transmitting source RS with less number of ports when corresponding TCI state in semi-active status is to reduce the effort on source RS transmission.

According to some embodiments, a WTRU may be configured with a QCL configuration of a TCI state, where the QCL configuration contains a source RS configuration. The source RS configuration indicating the WTRU with a source RS. In other words, the source RS configuration indicating the WTRU with a source RS which is transmitted on a set of source RS resources. It is noted that, the set of source RS resources may be comprised of (or may be divided into) multiple sub-sets of source RS resources. It is noted that, in certain embodiments, a source RS configuration indicating a source RS may be interpreted as the source RS configuration indicating an ID of the source RS.

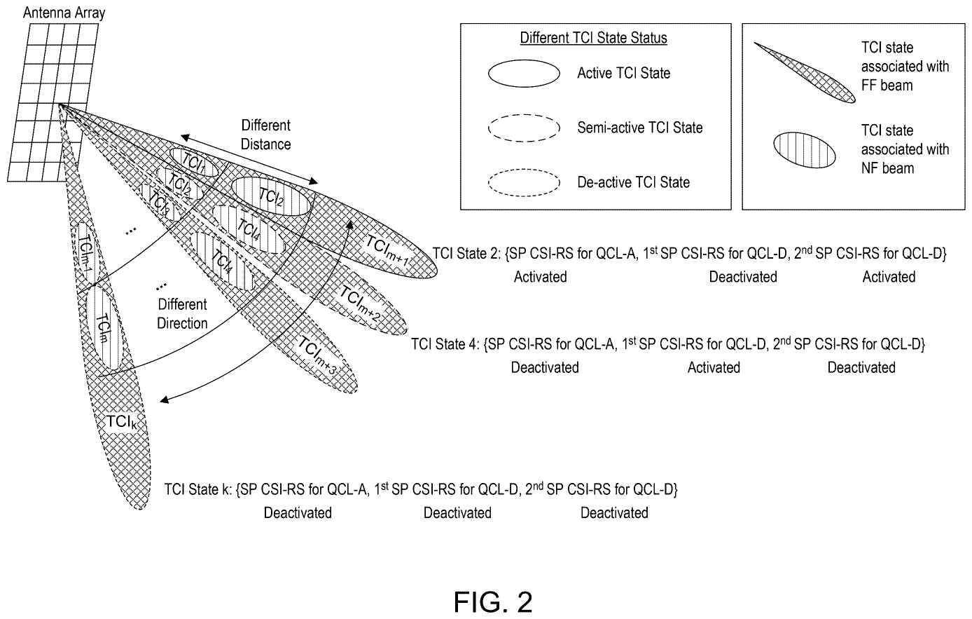

FIG. 5 illustrates an example of a port pattern configuration, according to some embodiments. For example, the WTRU may further be configured with a port pattern configuration, which is associated with the source RS configuration, indicating one or multiple port pattern(s) the network (e.g., gNB) may apply for the source RS transmission, as shown in the example of FIG. 5. As one example, a port pattern may be, but not limited to be, defined as: a number of ports applied for the corresponding source RS transmission; one or multiple or all sub-set(s) of source RS resource the source RS is transmitted on; and/or a particular RS density in the frequency domain, such as a number of resource elements per port per resource block. The port pattern may be, but not limited to be, indicated by a Port Pattern Indicator (PPI) carried by the source RS configuration.

In the example of FIG. 5, the WTRU may be configured with port pattern configurations a, b and c. The port pattern configuration a indicates the source RS is transmitted via Tx port n, n+1, n+2 and n+3. The port pattern configuration b indicates the source RS is transmitted via Tx port n+2 and n+3. The port pattern configuration c indicates the source RS is transmitted via Tx n+3 only. Each of the port pattern configurations a, b and c may be associated with individual PPI(s). It is assumed that the source RS transmission overhead may be in proportion to the number of ports applied for source RS transmission. In other words, the fewer number of ports that are applied, the less the overhead may be. Hence, to save source RS transmission overhead, the source RS may only need to be transmitted with proper port numbers. That is, the WTRU may be dynamically indicated with different number of ports for a source RS (e.g., via PPI or via an indication that switches a TCI status of a TCI state that comprises the source RS). The WTRU may be indicated, e.g., via PPI, which of the Tx port(s) is applied for corresponding source RS transmission.

In one embodiment, the PPI may indicate, to the WTRU, a first port pattern and a second port pattern for the source RS configuration of the TCI state. For example, the first port pattern is a first number of ports the source RS are transmitted with, and the first port pattern also includes the sub-set(s) of source RS resource the source RS are transmitted on. The second port pattern is a second number of ports the source RS are transmitted with, and the second port pattern also includes the sub-set(s) of source RS resource the source RS are transmitted on. The first number of ports may be different than the second number. In addition, the WTRU may be configured with a first ATSI associated with the first port pattern and a second ATSI associated with the second port pattern. The first ATSI indicates that the first port pattern is associated with a first TCI status, and the second ATSI indicates that the second port pattern is associated with a second TCI status.

Some embodiments may include a configuration of trigger state. As introduced above, there is a variety of mechanisms that can be implemented to reduce source RS (transmission) overhead in NF. For example, configuring source RS to be transmitted in different time-domain properties, configuring source RS to be transmitted with different port patterns and configuring multiple source RSs for a type of QCL property estimation. The introduced mechanisms increase the flexibility on using different configurations to reduce the RS overhead, however it also brings up the challenge on control signalling overhead as well as the complexity of the RS transmission management. Hence, to save the control signaling overhead and/or reducing the complexity of dynamic configuration switching, an embodiment provides a source RS trigger state mechanism as discussed in more detail in the following. The source RS trigger state mechanism can facilitate the source RS transmission management and reducing RS transmission overhead from the network's (e.g., gNB's) perspective.

By implementing the source RS trigger state mechanism, a number of source RS related configurations can be grouped as a source RS trigger state. A WTRU can be dynamically indicated with a number of source RS related configurations in an efficient way (e.g., indicated through the source RS trigger state).

Some embodiments may include or provide an association between source RS trigger states and TCI states. For example, a WTRU may be configured with a source RS trigger state via a trigger state configuration. The trigger state configuration may be, but not limited to be, configured by the network (e.g., gNB) via RRC signaling.

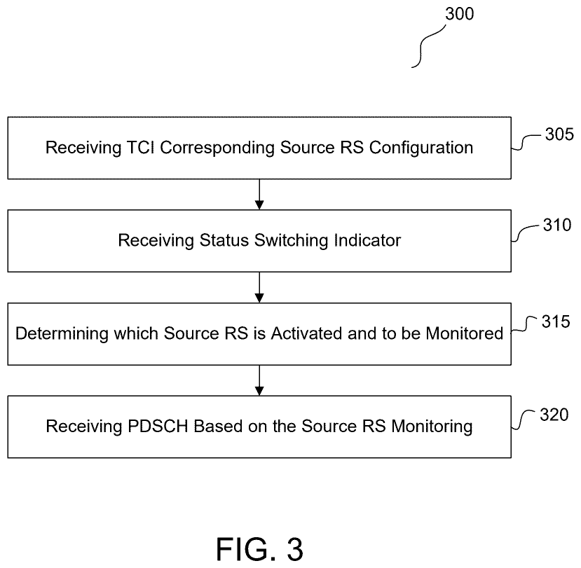

FIG. 6 illustrates an example association between TCI state (configuration) and source RS trigger states, according to some embodiments. For example, the WTRU may be configured with an association between source RS trigger state(s) 610 and TCI state(s) 605, as shown in the example of FIG. 6. For example, the WTRU may be configured with a first multiple source RS trigger states to be associated with a first TCI state, and the UE may be configured with a second multiple source RS trigger states to be associated with a second TCI state.

In one embodiment, the source RS trigger state may be explicitly associated with a TCI state via a trigger state (TS) ID. Specifically, the WTRU may be indicated, via a TS ID, a TCI state that is associated with a source RS trigger state. For example, a TCI state configuration may carry a TS ID of a source RS trigger state. The WTRU may determine that the TCI state is associated with the corresponding source RS trigger state.

In an embodiment, the source RS trigger state may be implicitly associated with a TCI state via a TCI state ID and TS ID. Specifically, the UE may determine the TCI state is associated with the source trigger state based on the value of the TCI state ID and the value of the TS ID.

According to certain embodiments, each source RS trigger state may be configured to be associated with a TS ID. In one embodiment, the WTRU may be explicitly indicated with TS ID to be associated with at least a source RS trigger state. The TS ID may be configured via a RRC signaling.

In an embodiment, the TS ID may be determined by the WTRU. That is, for each of configured source RS trigger states, the WTRU may implicitly determine a TS ID based on an order of the configured source RS trigger states. For example, the UE may be configured with a number of source RS trigger states via a RRC signaling. Specifically, each of the number of source RS trigger states may be configured via an RRC Information Element (IE). That is, the WTRU may be configured with the number of RRC IEs for the number of source RS trigger states. The WTRU may determine a TS ID for a source RS trigger state based on an order of a RRC IE, associated with the source RS trigger state, within the number of RRC IEs.

According to certain embodiments, the TS ID may be either unique in the UE, serving cell groups, serving cell, BWP or in a TCI state. That is, for example, in case of the TS ID is unique in a TCI state configured to a WTRU, a TS ID of a source RS trigger state of a TCI state is different than a TS ID of another source RS trigger state of the TCI state.

For example, the WTRU may be configured with a TCI state, and the TCI state may be associated with a first source RS trigger state and a second source RS trigger state. The first source RS trigger state is with a first TS ID and the second source RS trigger state is with a second TS ID. The first TS ID may be different from second TS ID.

For example, the WTRU may be configured with a first TCI state, and the first TCI state may be associated with a first source RS trigger state and a second source RS trigger state. The first source RS trigger state is with a first TS ID and the second source RS trigger state is with a second TS ID. The WTRU may also be configured with a second TCI state, and the second TCI state may be associated with a third source RS trigger state and a fourth source RS trigger state. The third source RS trigger state is with a third TS ID and the fourth source RS trigger state is with a fourth TS ID. The first TS ID may be different from second TS ID but can be same as either the third TS ID or the fourth ID.

In one embodiment, the TS ID may be applied for indicating the WTRU to apply or switch the configurations derived from the source RS trigger state which identified by the TS ID. In an embodiment, the TS ID may be applied for indicating the WTRU to apply the configurations, derived from the source RS trigger state which identified by the TS ID, for one or multiple particular channel(s) reception (or transmission).

In a further embodiment, a first configured source RS trigger state, identified by a first TS ID, may be indicated to be associated with a second configured source RS trigger state by a second TS ID identifying the second source RS trigger state. That is, the WTRU may be indicate that a number of source RS trigger states are associated with each other by the TS IDs of the number of source RS trigger states.

Certain embodiments may include configuring (multiple) source RS trigger state(s). Certain embodiments may provide two alternative approaches for configuring source RS trigger state via trigger state configuration: a source RS level approach and TCI state level approach.

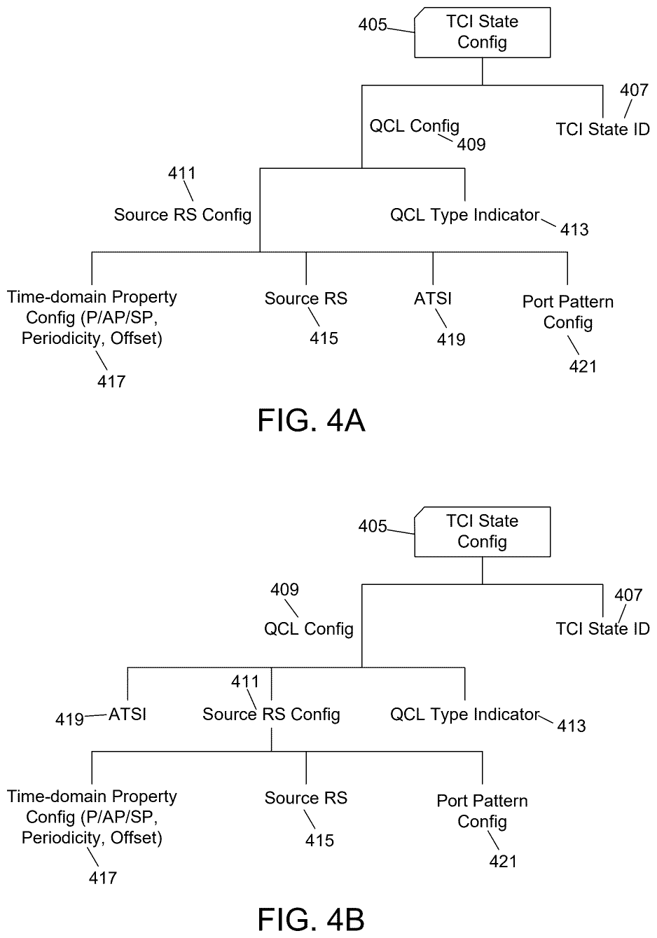

FIG. 7 illustrates an example configuration of Source RS level approach source RS trigger state, according to an embodiment. In the source RS level approach source RS trigger state configuration, as shown in the example of FIG. 7, a source RS configured for a TCI state may be associated with multiple source RS trigger states 710. Each source RS trigger state 710 may be associated with a TS ID 715, a QCL type indicator 720, a time-domain property configuration 725 and a port pattern configuration 730. By implementing the Source RS level approach, a source RS configured for a TCI state can be any of: (i) dynamically indicated, via the QCL type indicator, to be applied for different types of QCL property estimation; (ii) dynamically indicated, via the Time-domain configuration, to be transmitted with different time-domain properties; and/or (iii) dynamically indicated, via the Port Pattern configuration, to be transmitted with different port patterns.

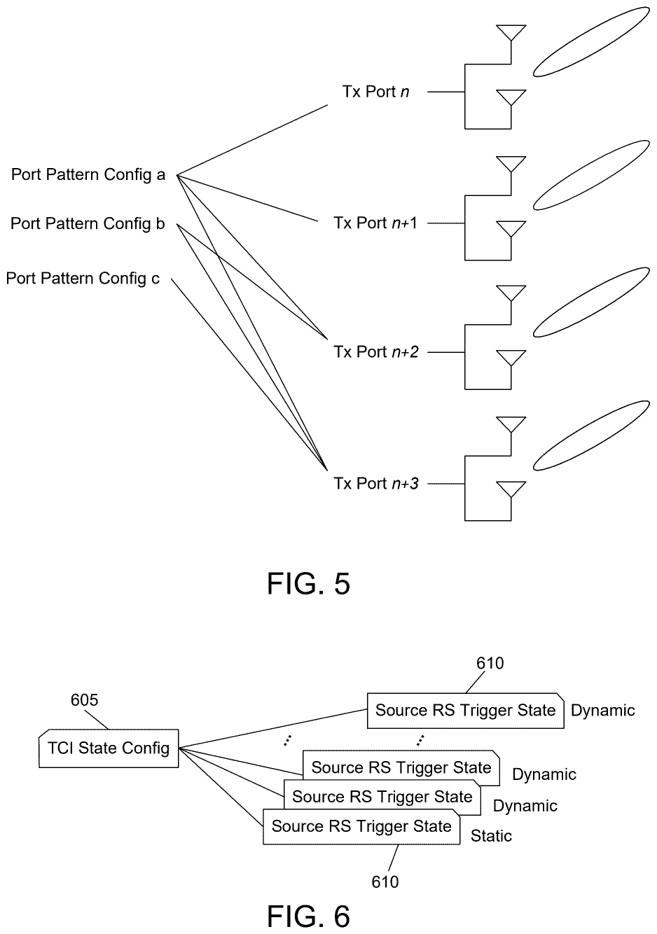

FIG. 8 illustrates an example configuration of TCI state level approach source RS trigger state, according to certain embodiments. In the TCI state level approach source RS trigger state configuration, a TCI state may be associated with multiple source RS trigger states 810, as shown in the example of FIG. 8. Each source RS trigger state 810 may be associated with a source RS configuration 818, a TS ID 815, a QCL type indicator 820, a time-domain property configuration 825 and a port pattern configuration 830. By implementing the TCI state level approach, a TCI state can be dynamically indicated, via the source RS configuration, to apply different source RS for QCL property estimation. The source RS indicated (or determined) by the Source RS configuration can be any of: (i) dynamically indicated, via the QCL type indicator, to be applied for different types of QCL property estimation; (ii) dynamically indicated, via the Time-domain configuration, to be transmitted with different time-domain properties; and/or (iii) dynamically indicated, via the Port Pattern configuration, to be transmitted with different port patterns.

According to some embodiments, a WTRU may be configured with multiple source RS trigger states. The multiple source RS trigger states may be, but not limited to be, configured by the network (e.g., gNB) via RRC signaling. According to the multiple source RS trigger states corresponding RRC pre-configuration, the WTRU may be further indicated to apply one or multiple of the multiple source RS trigger states. The one or multiple of the multiple source RS trigger states may be, but not limited to be, indicated by the network (e.g., gNB) via DL MAC CE and/or DCI.

In one embodiment, a source RS trigger state is defined as a logical configuration set which contain configurations related to QCL type, time-domain property and/or port pattern. Specifically, a source RS trigger state may be associated with QCL type indicator, time-domain property configuration and/or port pattern indicator. More specifically, a source RS trigger state may be associated with a particular type of QCL indicated by the QCL type indicator, a time-domain property indicated by the time-domain property configuration, and/or port pattern indicated (or determined) based on the port pattern indicator.

According to some embodiments, an initial trigger state may be configured. For example, among the multiple source RS trigger states configured for a TCI state, one source RS trigger state may be indicated to be an initial source RS trigger state. The initial source RS trigger state may be applied by the WTRU for an associated TCI state when any of: the associated TCI state is in a particular TCI status (e.g., semi-active status); the associated TCI state is configured by the RRC but not yet be activated; and/or the associated TCI state is indicated to be active but NO any source RS trigger state is indicated to be applied for the associated TCI state.

In some embodiments, a dedicated and/or dynamic trigger state may be configured. For example, among the multiple source RS trigger states configured for a TCI state, one source RS trigger state may be indicated to be a dedicated source RS trigger state and the remaining source RS trigger state may be indicated as dynamic source RS trigger state.

In one embodiment, the dedicated source RS trigger state is for a first specific type of source RS, while the dynamic source RS trigger state(s) is for a second specific type of source RS.

In a further embodiment, the dedicated source RS trigger state may be applied when the TCI state is indicated to be applied (e.g., for PDSCH reception/PUSCH transmission) but no source RS trigger state is indicated.

In certain embodiments, only the dynamic source RS trigger state may be applied for source RS trigger state indication. For example, a UE may be indicated by the network (e.g., gNB), via a trigger state indicator, to apply a particular source RS trigger state for the TCI state. In this example, the trigger state indicator only refers to the dynamic source RS trigger states but does not refer to the dedicated source RS trigger state.

Some embodiments may include or may provide a determination of QCL type specific RS transmission (SP RS). To support accurate QCL property estimation, a WTRU may be configured with multiple source RSs for a TCI state. Each of the multiple source RSs may be applied by the WTRU for different types of QCL property estimation. For example, a first source RS is configured for a first type of QCL property (e.g., QCL type A) estimation, and a second source RS is configured for a second type of QCL property (e.g., QCL type D) estimation. However, to meet particular TCI status switching delay (e.g., switching from a first TCI status to a second TCI status) requirement for a TCI state which is in the first TCI status, the WTRU may not need to monitor both of the first source RS and the second source RS. That is, for example, the WTRU may only need to monitor the second source RS for tracking the spatial domain properties. In other words, the WTRU may only need to monitor the first source RS after the TCI state is switched from the first TCI status to the second TCI status. Hence, the overhead on the first source RS transmission may be saved in case of the TCI state is in the second TCI status. The first and second TCI status may be in either active, de-active or semi-active status.

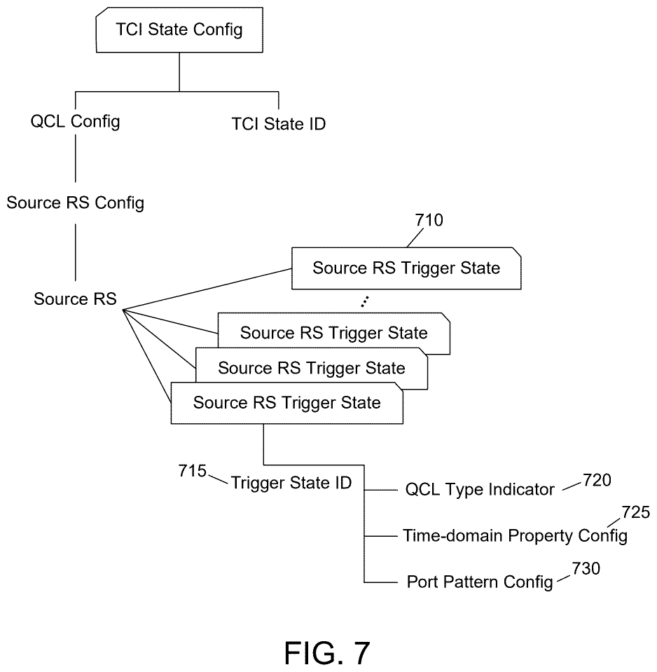

In one embodiment, the first source RS may be dynamically, or semi-statically, turned on and off according to the TCI state status. For example, the time-domain property of the first source RS may be configured as Semi-Persistent (SP) type by the time-domain property configuration. That is, in one example, the first source RS may be configured as SP which may be turned off by the network (e.g., gNB) when the TCI state is in the first TCI status and be turned on by the network (e.g., gNB) when the TCI state is in (switched to) the second TCI status. From the WTRU perspective, in one example, the first source RS may be configured as SP which may be determined as being turned off (e.g., deactivated) when the TCI state is in the first TCI status and be determined as being turned on (e.g., activated) when the TCI state is in (switched to) the second TCI status. In the meantime, the second source RS of the TCI state may be considered as always turned on (e.g., activated) no matter the TCI state is in either the first TCI status of the second TCI status. That is, the second source RS may be a periodic RS which is transmitted periodically, or assumed by the UE to be transmitted periodically, no matter which TCI status it is in. FIG. 9 illustrates an example of source RS (de)activation according to TCI status, in accordance with some embodiments.

In a further embodiment, the WTRU may be configured with three source RS for a TCI state. That is, a first source RS is configured for a first type of QCL property (e.g., QCL type A) estimation, a second source RS is configured for a second type of QCL property (e.g., QCL type D) estimation and a third source RS is also configured for the second type of QCL property (e.g., QCL type D) estimation.

The first, second and third source RS may be dynamically, or semi-statically, turned on and off, or activated and deactivated from the WTRU's perspective, according to the TCI state status. For example, all the time-domain properties of the first, second and third source RS may be configured as Semi-Persistent (SP) type by the time-domain property configuration. But the source RS transmission periodicity of the second source RS and the third source RS may be different. The first source RS and second source RS may be turned off by the network (e.g., gNB) when the TCI state is in the first TCI status and be turned on by the network (e.g., gNB) when the TCI state is in (switched to) the second TCI status. The third source may be turned on by the network (e.g., gNB) when the TCI state is in the first TCI status and be turned off by the network (e.g., gNB) when the TCI state is in (switched to) the second TCI status. From the WTRU perspective, in one example, the first source RS and the second source RS may be configured as SP which may be determined as being turned off (e.g., deactivated) when the TCI state is in the first TCI status and be determined as being turned on (e.g., activated) when the TCI state is in (switched to) the second TCI status. Specifically, the WTRU may determine the first source RS and the second source RS being turned off (e.g., deactivated) after the WTRU transmitting a HARQ feedback in response to receiving a DCI indicating to switch the TCI state to the first status. In the meantime, the third source RS of the TCI state may be configured as SP which may be determined as being turned on (e.g., activated) when the TCI state is in the first TCI status and be determined as being turned off (e.g., deactivated) when the TCI state is in (switched to) the second TCI. Specifically, the WTRU may determine the third source RS is turned on/off (e.g., activated/deactivated) after transmitting an HARQ feedback in response to receiving a DCI indicating to switch the TCI state to first TCI status/second TCI status. The first and second TCI status may be either active, de-active or semi-active status.

It is noted that, in certain embodiments, a source RS being turned on may be interpreted as the source RS is activated, e.g., from the WTRU's perspective. A source RS being turned off may be interpreted as the source RS is de-activated, e.g., from the WTRU's perspective.

It is also noted that, in certain embodiments, a source RS being turned on may be interpreted as the source RS is being transmitted. A source RS being turned off may be interpreted as the source RS is not being transmitted.

Hence, note that it may be possible that a source RS may be transmitted by the network even if it is deactivated from the perspective of a WTRU. For instance, an RS may be activated for a first WTRU and deactivated for a second WTRU. If the network does not transmit a source RS that is activated from the perspective of a WTRU, it may have negative consequences.

To dynamically turn on/off (the transmission of) a first source RS, the WTRU may need to receive additional specific control signaling to indicate the on/off status of the first source RS. The additional specific control signals transmission may not only be considered as an overhead but also increase the TCI status switching delay from the first TCI status to the second TCI status. That is, for example, after being indicated to switch the TCI state from the first TCI status to the second TCI status, the WTRU needs to receive the additional specific control signal which may cause some delays. In some embodiments, the specific control signaling may be interpreted as any control signal being defined and/or transmitted for controlling particular procedure, function, parameter, and the like, etc. For example, the control signaling may be, but not limited to be, a DCI, UCI, a MAC CE and/or a RRC configuration.

For example, to alleviate the overhead and/or the delay mentioned above, the WTRU may determine whether the first source RS is activated or deactivated based on the TCI status of the TCI state that comprises the source RS. That is, the WTRU may determine the first source RS is activated or deactivated based on the TCI status of the TCI state.

Specifically, e.g., to alleviate the overhead and/or the delay mentioned above, the WTRU may determine whether the first source RS is activated or deactivated based on the TCI status of the TCI state and a ATSI associated with the first source RS. That is, the WTRU may determine whether the first source RS is activated or deactivated based on the TCI status of the TCI state and based on the indication of the ATSI configured to be associated with the first source RS. For example, a WTRU is configured with the first source RS via a source RS configuration. The source RS configuration may contain an ATSI. The ATSI indicates, to the WTRU, the first source RS is associated with the second TCI status.

More specifically, e.g., to alleviate the overhead and/or the delay mentioned above, the WTRU may determine whether the first source RS is activated or deactivated based on a TCI status switching indicator and a ATSI associated with the first source RS. Wherein the TCI status switching indicator is received from the gNB, and the TCI status switching indicator indicates the WTRU to switch the TCI state from the first TCI status to the second TCI status.

In one embodiment, the first source RS may be activated in response to the TCI state being switched from the first TCI status to the second TCI status. In other words, the WTRU determines that the first source RS is deactivated in response to the TCI state being switched from the second TCI status to the first TCI status.

In a further embodiment, the WTRU determines that the first source RS is activated in response to receiving a command which indicated the WTRU to switch the TCI state from the first TCI status to the second TCI status. In other words, the WTRU determines that the first source RS is deactivated in response to receiving a command which indicated the WTRU to switch the TCI state from the second TCI status to the first TCI status.

In certain embodiments, the WTRU determines that the first source RS is activated in response to the WTRU determining that the TCI state needs to be switched from the first TCI status to the second TCI status. In other words, the WTRU determines the first source RS is de-activated in response to the WTRU determining the TCI state needs to be switched from the second TCI status to the first TCI status.

In an embodiment, a WTRU is configured with a first source RS via a first source RS configuration. The first source RS configuration may contain a first ATSI. The first ATSI indicates the UE that the first source RS is associated with the second TCI status. The WTRU may be configured with a second source RS via a second source RS configuration. The second source RS configuration may contain a second ATSI. The second ATSI indicates the WTRU the second source RS is associated with the first TCI status. The WTRU may determine the first source RS is activated and the second source RS is de-activated in response to the WTRU determining the TCI state needs to be switched from the first TCI status to the second TCI status. The WTRU may determine the first source RS is de-activated and the second source RS is activated in response to the WTRU determining the TCI state needs to be switched from the second TCI status to the first TCI status.

In an embodiment, the time-domain property of the first source RS may be configured as Periodic (P) type by the time-domain property configuration. It is noted that some embodiments introduced above for the determination of the activation/deactivation of the first source RS and the second source RS may be adopted when the first source is configured as P type.

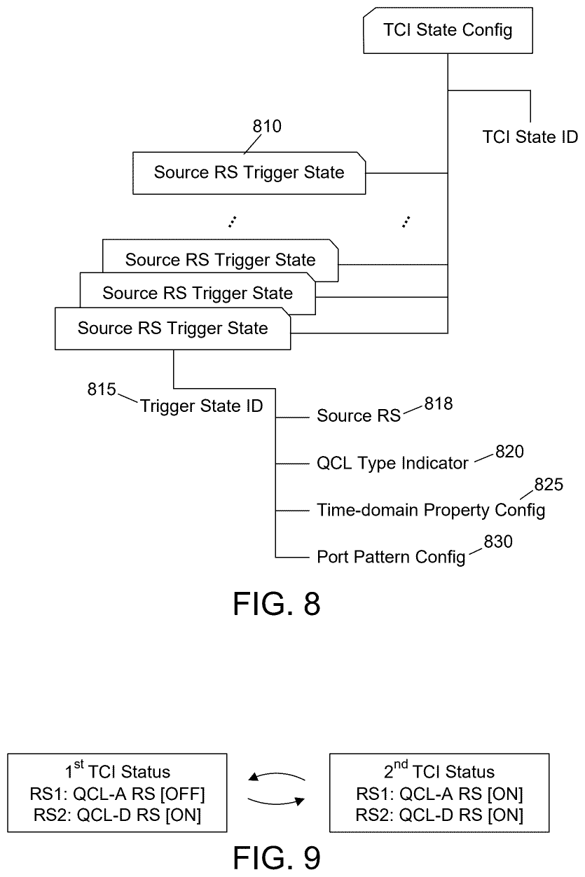

FIG. 10A illustrates an example signaling diagram, according to an embodiment. As illustrated in the example of FIG. 10A, a WTRU may be configured with a TCI state with source RS being configured as periodic (i.e., periodic CSI-RS). Hence, the WTRU might receive periodic CSI-RS, as shown at 1001 and 1002. Unless the TCI state is activated (as shown at 1003), the WTRU may not need to monitor the periodic CSI-RS. That is, the UE may start to monitor the periodic CSI-RS after the TCI state is activated at 1003 and the WTRU may transmit HARQ ACK to the gNB at 1004. In other words, the RS transmission at 1001 and 1002 may be skipped by the gNB if no other UE needs it. In the example of FIG. 10A, the WTRU may monitor for and/or receive the periodic CSI-RS as shown at 1005 and/or 1006.

FIG. 10B illustrates an example signaling diagram, according to an embodiment. As shown in the example of FIG. 10B, to reduce the RS transmission overhead, the gNB may configure the source RS of the TCI state as aperiodic (aperiodic CSI-RS). In the example of FIG. 10B, the TCI state may be activated at 1010 and the WTRU may transmit HARQ-ACK at 1011. The aperiodic CSI-RS may be activated, as shown at 1013, when the corresponding TCI state is activated. However, the aperiodic CSI-RS may need to be activated by the extra signaling at 1013 and the HARQ-ACK at 1014, which causes signaling overhead. In addition, it may cause some extra delay before the WTRU has available RS to be monitored for the TCI state (e.g., between the HARQ-ACK at 1011 and the HARQ-ACK at 1014). The WTRU may monitor for and/or receive the aperiodic CSI-RS as shown at 1015 and 1016.

To alleviate the signaling overhead and delay drawback, certain embodiments provide the mechanism, as illustrated in the example of FIG. 10C, which triggered the aperiodic CSI-RS activation by the TCI state activation command at 1021. The WTRU may determine the aperiodic CSI-RS is transmitted, as shown at 1023 after receiving the TCI state activation command at 1021, after determining the TCI state is activated, and/or after sending HARQ ACK to the gNB at 1022. In some embodiments, the WTRU may receive periodic CSI-RS as shown at 1024 and/or 1025.

Some embodiments may include or provide SP RS activation and/or deactivation. Consider a source RS that was activated for a WTRU upon the switching of the TCI status of a TCI state that comprises the source RS, as discussed above. The WTRU may subsequently receive an indication to deactivate the source RS, e.g., by an indication to deactivate a set of RS that includes the source RS, e.g., an RS resource set. The WTRU may determine the source RS is deactivated regardless of the TCI state.

In one embodiment, the source RS is deactivated for the WTRU. For a subsequent application of the TCI state, the WTRU may maintain the QCL parameter(s) estimated from the source RS prior to the deactivation.

In a further embodiment, the WTRU may keep the source RS activated, contrary to the deactivation indication. However, the WTRU may deactivate one or more of the other RS in the set of RS, e.g., the RS in the set of RS that are not included in TCI states with TCI status associated with activated source RS.

Consider a source RS that is included in a TCI state that is in a TCI status associated with the source RS being deactivated. The source RS is also included in a set of RS, e.g., an RS resource set, that is deactivated. Now, the WTRU may receive an indication to switch the TCI status of the TCI state, to a TCI status associated with the source RS being activated.

In an embodiment, the other RS in the set of RS may remain deactivated, while only the source RS is activated. In a further embodiment, the other RS in the set of RS may also be activated upon the activation of the source RS, even though the other RS might not be included in the TCI state.

Some embodiments may include or provide for failure handling. For example, a WTRU may be configured with a TCI state. The TCI state is configured to associate with a first source RS, a second source RS and a third source RS. The first source RS is configured to be applied for QCL-D property estimation when the TCI state is in a first TCI status (e.g., active status as indicated by a ATSI). The second source RS is configured to be applied for QCL-D property estimation when the TCI state is in a second TCI status (e.g., semi-active status as indicated by a ATSI). The third source RS is configured to be applied for QCL-A property estimation when the TCI state is in the first TCI status. That is, the WTRU may determine the first source RS and the third source RS are transmitted if the TCI state is in the first TCI status. The WTRU may determine the second source RS is transmitted if the TCI state is in the second TCI status. However, additional WTRU behavior may need to be defined in some cases of the WTRU additionally receiving RS (de)activation command, from the network (e.g., gNB), to activate or deactivate the source associated with TCI state.

For example, in a first scenario, while the TCI state is in the first TCI status, the WTRU receives a deactivation command from the network (e.g., gNB) to deactivate the first source RS. The WTRU may execute one of multiple alternatives. In one embodiment, the WTRU may determine to keep applying the first source RS for QCL-D property estimation. That is, the UE may determine the first source RS is transmitted regards of the deactivation command reception. In a further embodiment, the WTRU may determine to apply the second source RS for the QCL-D property estimation. That is, the WTRU may determine the first source RS is not transmitted in response to the deactivation command reception, and the WTRU may determine the second source RS is transmitted in response to the deactivation command reception. In a further embodiment, the WTRU may determine to apply the third source RS for the QCL-D property estimation. That is, the WTRU may determine the first source RS is not transmitted in response to the deactivation command reception.

As another example, in a second scenario, while the TCI state is in the second TCI status, the WTRU receives an activation command from the network (e.g., gNB) to activate the first source RS. The WTRU may execute one of multiple alternatives. In one embodiment, the WTRU may determine to apply the first source RS for the QCL-D property estimation. That is, the WTRU may determine the first source RS is transmitted, and determine to apply the first source RS for the QCL-D property estimation instead of applying the second source RS. In a further embodiment, the WTRU may determine to keep apply the second source RS for the QCL-D property estimation. That is, the WTRU may determine the first source RS is transmitted, but the WTRU determines to keep applying the second source RS for the QCL-D property estimation. In a further embodiment, the WTRU may determine the second source RS is transmitted only when determining the first source RS is not transmitted.

As another example, in a third scenario, after the TCI state be switched to the second TCI status, the WTRU determines the first source RS is transmitted in a period of time. That is, the WTRU may determine the first source RS is not transmitted after a period of time after the TCI state switched to the second TCI status. The period of time may be pre-configured by the network (e.g., gNB) through RRC signaling.

Some embodiments may include or provide a determination of RS transmission periodicity (P RS). A WTRU may be configured with a source RS for a TCI state. The source RS is applied for a specific type of QCL property (e.g., QCL type D) estimation. To support accurate QCL property estimation, the source RS may need to be transmitted periodically. However, the required minimum periodicity or frequency (i.e., interval/how frequent) of the source RS transmission may depend on the TCI status of the TCI state. For example, to meet a particular TCI status switching delay (e.g., switching from a first TCI status to a second TCI status) requirement for a TCI state which is in the first TCI status, the WTRU may not need to receive the source RS every X1 milliseconds (ms). In opposite, while the TCI state in the second TCI status, the source RS needs to be monitored every X2 ms, where X2 may be smaller than X1. Hence, the transmission overhead for transmitting the source RS with X1 periodicity may be less than the transmission overhead for transmitting the source RS with X2 periodicity. In a state-of-the-art system, the network may need to configure the WTRU with the source RS periodicity of X2, which the WTRU may assume regardless of the TCI status of the TCI state. Certain embodiments described herein introduce a TCI status dependent source RS periodicity. Hence, the overhead on the source RS transmission may be saved in case of the TCI state is in the first TCI status. It is noted that, as used herein, X1 may represent a first periodicity and X2 may represent a second periodicity.

In an embodiment, the source RS periodicity may be dynamically adapted to either X1periodicity or with X2 periodicity according to the TCI state status. For example, a first time-domain property of the source RS may be configured with first frequencies (i.e., the X1) by a first time-domain property configuration. Additionally, a second time-domain property of the source RS may be configured with second frequencies (i.e., the X2) by a second time-domain property configuration. That is, in one embodiment, the source RS may be transmitted with X1 periodicity when the TCI state is in (switched to) the first TCI status and be transmitted with X2 periodicity when the TCI state is in (switched to) the second TCI status. It is noted that, the WTRU may determine the source RS transmission periodicity is changed from X1 to X2 after the transmission a HARQ-ACK feedback in response to receiving a DCI indicating the TCI state status is switched to the second TCI status.

From the WTRU perspective, in one embodiment, the source RS may be determined as being transmitted with X1 periodicity when the TCI state is in the first TCI status and be determined as being transmitted with X2 periodicity when the TCI state is in the second TCI status.

To dynamically change the source RS transmission periodicity in state-of-the-art systems, the WTRU may need to receive additional specific control signals to be indicated the transmission periodicity switching (e.g., RRC reconfigures the corresponding source RS transmission periodicity). The additional specific control signals transmission may not only be considered as an overhead but also increase the TCI status switching delay from the first TCI status to the second TCI status. That is, for example, after being indicated to switch the TCI state from the first TCI status to the second TCI status, the WTRU needs to receive the additional specific control signal which may cause some delays.

For example, to alleviate the overhead and/or the delay mentioned above, the WTRU may determine whether the source RS is transmitted with either X1 periodicity or X2 periodicity based on the TCI status of the TCI state. That is, the WTRU may determine the first source RS is transmitted with either X1 or X2 periodicity based on the TCI status of the TCI state.

Specifically, e.g., to alleviate the overhead and/or the delay mentioned above, the WTRU may determine whether the source RS is transmitted with X1 periodicity or X2 periodicity based on the TCI status of the TCI state and an ATSI associated with the source RS. That is, the WTRU may determine the source RS is transmitted with X1 periodicity or X2 periodicity based on the TCI status of the TCI state and based on the indication of the ATSI configured to be associated with the source RS. For example, a WTRU may be configured with the X1 periodicity via a first time-domain property configuration. The first time-domain property configuration may contain a first ATSI. The first ATSI indicates the UE the X1 is associated with the first TCI status, and the WTRU may be configured with the X2 periodicity via a second time-domain property configuration. The second time-domain property configuration may contain a second ATSI. The second ATSI indicates, to the WTRU, the X2 is associated with the second TCI status.

More specifically, e.g., to alleviate the overhead and/or the delay mentioned above, the WTRU may determine whether the source RS is transmitted with X1 periodicity or X2 periodicity based on a TCI status switching indicator and the ATSIs associated with the source RS. The TCI status switching indicator may be received from the network (e.g., gNB), and the TCI status switching indicator indicates the WTRU to switch the TCI state from the first TCI status to the second TCI status.

In an embodiment, the source RS is transmitted with X2 periodicity in response to the TCI state being switched from the first TCI status to the second TCI status. In other words, the WTRU may determine that the source RS is transmitted with X1 periodicity based on the TCI state being switched from the second TCI status to the first TCI status.

In an embodiment, the WTRU determines that the source RS is transmitted with X2 periodicity in response to the WTRU receiving a command which indicates the WTRU to switch the TCI state from the first TCI status to the second TCI status. In other words, the WTRU determines that the source RS is transmitted with X1 periodicity based on the WTRU receiving a command which indicates the WTRU to switch the TCI state from the second TCI status to the first TCI status.

In further embodiments, the WTRU determines that the source RS is transmitted with X2 periodicity in response to the WTRU determining the TCI state needs to be switched from the first TCI status to the second TCI status. In other words, the WTRU determines that the source RS is transmitted with X1 periodicity based on the WTRU determining that the TCI state needs to be switched from the second TCI status to the first TCI status.

In some embodiments, a source RS may be included in multiple TCI states, each with a TCI status that may be the same or different. The different TCI statuses may correspond to different source RS periodicities. In that case, the WTRU may determine the source RS periodicity based on the TCI status, among the TCI statuses of TCI states comprising the source RS, that corresponds to the shortest periodicity. In other words, upon the switching of the TCI status of a TCI state among the multiple TCI states to a first TCI status, the WTRU may determine the source RS periodicity based on the first TCI status if the periodicity associated with the first TCI status is less than (or less than or equal to) the periodicities associated with the TCI statuses of the other TCI states among the multiple TCI states that include the source RS. The benefit of this approach is that TCI status that requires the shortest periodicity, e.g., the TCI status with highest source RS monitoring requirements on the WTRU, may be used to determine the periodicity, thereby guaranteeing that the WTRU can meet the requirements.

In an example, active TCI status is associated with the shortest periodicity of a source RS. Consider the case that the source RS is included in multiple TCI states. Even if one or more of the multiple TCI states are in a de-active, or semi-active status, the WTRU may determine the source RS periodicity based on the periodicity associated with active status as long as at least one TCI state of the multiple TCI states is in active status.

In some embodiments, the WTRU may determine a source RS periodicity based on the TCI status of a TCI state that includes the source RS if the source RS is configured with a first QCL type in the TCI state, e.g., type A or type D. If the source RS is not configured with the first QCL type in the TCI state, but with a second QCL type (e.g., type D or type A) different from the first, the WTRU may use the same source RS periodicity, regardless of the TCI status, e.g., a mandatory configured source RS periodicity.

In another example, the time-domain property configuration for the source RS may also include transmission (timing) offset. It is noted that certain embodiments introduced above for the determination of the source RS transmission periodicity may be adopted for determining the source RS transmission (timing) offset when the time-domain property configuration for the source RS include transmission (timing) offset.

In further embodiments, the WTRU may dynamically be indicated with one of the X1 and/or X2 through a DCI. For example, while a WTRU receiving a DCI scheduling a PDSCH reception by applying the TCI state, the DCI may carry an indicator that indicates to the WTRU the source RS of the TCI state is either transmitted by applying the first time-domain property configuration or is transmitted by applying the second time-domain property configuration. Specifically, the DCI may carry an indicator that indicates to the WTRU the source RS of the TCI state is either transmitted with X1 periodicity or is transmitted with X2 periodicity.

In an embodiment, the WTRU may be configured with a source RS for a TCI state. The source RS may be further configured to be associated with a time-domain property configuration. The time-domain property configuration indicates a first periodicity (X1) and a second periodicity (X2). The WTRU may determine the source RS is transmitted in the first periodicity when the TCI state is in a first TCI status, and the WTRU may determine the source RS is transmitted in the second periodicity when the TCI state is in a second and a third TCI status. The first, second and third TCI status may be either active, semi-active or de-active status. In one example, the first TCI status is de-active, the second TCI status is active, and the third TCI status is semi-active. In another example, the first TCI status is active, the second TCI status is de-active, and the third TCI status is semi-active.

According to some embodiments, a source RS may be configured with more than two periodicities, e.g., three periodicities (e.g., X1, X2, X3). The different periodicities may be associated with different TCI statuses. In a first example, X1 may be associated with de-active, X2 with semi-active, and X3 with active status. Alternatively, one or more periodicities may be associated with the same TCI status. For example, X1 may be associated with de-active TCI status, while X2 and X3 may be associated with active TCI status. For a TCI status with multiple associated periodicities, the WTRU may determine a periodicity from the multiple periodicities based on an additional criterion. For example, the WTRU may determine a first periodicity, from the multiple, if the TCI state is applied to the reception of a channel, e.g., PDCCH and/or PDSCH. Note that a TCI state may be active, but not applied to any channel, or active and applied to a channel. Also note that a TCI state may be applicable to a channel, e.g., PDCCH/PDSCH, upon reception of a TCI state indication, for instance in a DCI, or upon beam failure, for instance upon transmission of a beam failure recovery request. In the case of beam failure recovery, the applicable source RS for a channel may be an RS indicated in a beam failure recovery request rather than a source RS in a TCI state. In other words, the periodicity of an RS may be determined based on if it is applicable as QCL source RS to a channel, e.g., PDCCH/PDSCH, after being indicated to the network as a new RS, e.g., new beam RS, in a beam failure recovery request.

In certain embodiments, an RS is configured with multiple periodicities but is not configured as source RS in a TCI state. In other words, the RS is not a source RS. In this case, the WTRU may assume one of the periodicities, e.g., a mandatory configured periodicity (assuming that the other periodicities are optionally configured), or the shortest configured periodicity.

Some embodiments may include or provide for a determination of transmission ports of RS (P/SP RS). For example, as discussed in more detail below, a WTRU may be configured in the CSI report configuration. As one example, a CSI report may be configured with CSI-RS with N=32 ports. The WTRU may measure the CSI-RS with 32 ports. The CSI report is also configured with sub-configurations which indicate the pattern (e.g., N1=4 ports turned on, the rest are turned off). The WTRU reports a PMI with N1=4 ports. A single CSI report can have multiple sub-configurations (e.g., N1=4, N2=8), and the WTRU may report multiple PMIs for different number of ports, based on the same 32 port resource.

According to some embodiments, a WTRU may be configured with a source RS for a TCI states. The source RS is applied for a specific type of QCL property (e.g., QCL type D) estimation. To support accurate QCL property estimation, the source RS may need to be transmitted with a first number of ports (or first port pattern). However, the required port numbers (port pattern) for the source RS transmission may depend on the TCI status of the TCI state. For example, to meet particular TCI status switching delay (e.g., switching from a first TCI status to a second TCI status) requirement for a TCI state which is in the first TCI status, the source RS only need to be transmitted with a second number of ports (a second port pattern). That is, the WTRU is expected the source RS is transmitted with a second number of ports. Similarly, while the TCI state is in the second TCI status, the source RS needs to be transmitted with the first number of ports (the first port pattern). That is, the WTRU is expected the source RS is transmitted with a first number of ports. The second number may be smaller than the first number (the second port pattern may has less RS transmission overhead than the first port pattern). Hence, the transmission overhead for transmitting the source RS with the first number of ports may be less than the transmission overhead for transmitting the source RS with the second number of ports. As a result, the overhead on the source RS transmission may be saved in case of the TCI state is in the first TCI status.

In an embodiment, the source RS may be dynamically transmitted with either a first port pattern or with a second port pattern according to the TCI state status. For example, a first port pattern for the source RS may be configured by a first time-domain property configuration. Additionally, a second port pattern for the source RS may be configured by a second time-domain property configuration. That is, in one embodiment, the source RS may be transmitted with the second port pattern when the TCI state is in (switched to) the first TCI status and be transmitted with first port pattern when the TCI state is in (switched to) the second TCI status.

From the WTRU perspective, in one embodiment, the source RS may be determined as being transmitted with the second port pattern when the TCI state is in the first TCI status and be determined as being transmitted with the first port pattern when the TCI state is in the second TCI status.

For example, to dynamically switch the port pattern for the source RS transmission, the WTRU may need to receive addition specific control signals to be indicated the transmission frequency switching. The additional specific control signals transmission may not only be considered as an overhead but also increase the TCI status switching delay from the first TCI status to the second TCI status. That is, for example, after being indicated to switch the TCI state from the first TCI status to the second TCI status, the WTRU needs to receive the addition specific control signal which may cause some delays.

For example, to alleviate the overhead and/or the delay mentioned above, the WTRU may determine whether the source RS is transmitted with either the first port pattern or with the second port pattern based on the TCI status of the TCI state. That is, the WTRU may determine the source RS is transmitted with either the first port pattern X1 or the second port pattern based on the TCI status of the TCI state. It is noted that the WTRU may determine the source RS is transmitted with either the first port pattern or the second port pattern after the transmission a HARQ-ACK feedback in response to receiving a DCI indicating the TCI state status is switched.

Specifically, e.g., to alleviate the overhead and/or the delay mentioned above, the WTRU may determine whether the source RS is transmitted with the first port pattern or with the second port pattern based on the TCI status of the TCI state and an ATSI associated with the source RS. That is, the WTRU may determine the source RS is transmitted with the first port pattern or the second port pattern based on the TCI status of the TCI state and based on the indication of the ATSI(s) configured to be associated with the source RS. For example, a WTRU may be configured with the first port pattern via a first Port Pattern configuration. The first Port Pattern configuration may contain a first ATSI. The first ATSI indicates, to the WTRU, that the first port pattern is associated with the second TCI status. The WTRU may be configured with the second port pattern via a second Port Pattern configuration. The second Port Pattern configuration may contain a second ATSI. The second ATSI indicates, to the WTRU, that the second port pattern is associated with the first TCI status.

More specifically, e.g., to alleviate the overhead and/or the delay mentioned above, the WTRU may determine whether the source RS is transmitted with a first port pattern or a second port pattern based on a TCI status switching indicator and the ATSIs associated with the source RS. The TCI status switching indicator may be received from the network (e.g., gNB), and the TCI status switching indicator may indicate the WTRU to switch the TCI state from the first TCI status to the second TCI status.

In an embodiment, the source RS is transmitted with the first port pattern in response to the TCI state is switched from the first TCI status to the second TCI status. In other words, the WTRU may determine the source RS is transmitted with the second port pattern in response to the TCI state being switched from the second TCI status to the first TCI status.

In a further embodiment, the WTRU may determine the source RS is transmitted with the first port pattern in response to the WTRU receiving a command which indicated the UE to switch the TCI state from the first TCI status to the second TCI status. In other words, the WTRU determines the source RS is transmitted with the second port pattern in response to the WTRU receiving a command which indicated the WTRU to switch the TCI state from the second TCI status to the first TCI status.

In certain embodiments, the WTRU may determine the source RS is transmitted with the first port pattern in response to the WTRU determining the TCI state needs to be switched from the first TCI status to the second TCI status. In other words, the WTRU determines the source RS is transmitted with the second port pattern in response to the WTRU determining the TCI state needs to be switched from the second TCI status to the first TCI status.

According to some embodiments, the WTRU may dynamically be indicated with one of the first port pattern and the second port pattern through a DCI. For example, a WTRU may receive a DCI scheduling a PDSCH reception by applying the TCI state, where the DCI may carry an indication, such as a PPI, that indicates to the WTRU the source RS of the TCI state is either transmitted with the first port pattern or is transmitted with the second port pattern.

Some embodiments may include or provide for a trigger state based RS transmission control (SP/AP RS). As introduced above, the WTRU may be configured with multiple source RS trigger states via trigger state configuration. The WTRU may be further indicated that one or more of source RS trigger state(s) is applied. According to some embodiments discussed above (e.g., relating to the configuration of trigger state), a source RS trigger state may be associated with a combination of multiple configurations. Hence, the WTRU may determine that the source RS is transmitted by applying the configurations associated with the one or more indicated source RS trigger state(s). The one or more source RS trigger state may be, but not limited to be, indicated via layer 1 (L1) and/or layer 2 (L2) signaling. It is noted that, as should be understood, L1 may refer to the physical layer that may be responsible for, e.g., physical transmission of data in a communications system. It is further noted that, as should be understood, L2 may refer to the data link layer that may be responsible for, e.g., control information. Further it is noted that layer 3(L 3 ) my refer to the network layer that may be responsible for, e.g., enabling communication between devices on different networks.

The following examples may be based on the source RS level approach source RS trigger state configuration. In one example embodiment, the WTRU may be configured with a TCI state via a TCI state configuration. The TCI state configuration carrying a TCI state ID. The TCI state configuration carrying a first QCL configuration which carried a first QCL type indicator and a first source RS configuration. The TCI state configuration also carrying a second QCL type indicator and a second QCL configuration which carried a second source RS configuration. The first source RS configuration configures the WTRU with a first source RS, where the first source RS configuration further configures a source RS trigger state 1A and a source RS trigger state 1B. The second source RS configuration configures the WTRU with a second source RS, where the second source RS configuration further configures a source RS trigger state 2A and a source RS trigger state 2B. The WTRU may be further indicated, e.g., via a MAC CE or a DCI, which of the source RS trigger state is applied. For example, while receiving a MAC CE indicating the TCI state switching from de-active to active status, the MAC CE may also carry an indicator indicating one or more trigger state ID(s). The WTRU may determine that the source RS of the TCI state is transmitted by applying the configurations associated with the source RS trigger state identified by the trigger state ID. For example, while receiving a DCI indicating the TCI state is applied for a PDSCH reception, the DCI may also carry an indicator indicating one or more trigger state ID(s). The WTRU may determine the source RS of the TCI state is transmitted by applying the configurations associated with the source RS trigger state identified by the trigger state ID.

Specifically, the MAC CE may carry a first indicator indicating a first trigger state (e.g., 1A or 1B) for the first source RS, and may carry a second indicator indicating a second trigger state (e.g., 2A or 2B) for the second source RS. The WTRU may determine the first source RS and the second source RS of the TCI state are transmitted by applying the configurations associated with indicated source RS trigger states, respectively.

More specifically, while receiving a DCI indicating the TCI state is applied for a PDSCH reception, the DCI may carry a first indicator indicating a first trigger state (e.g., 1A or 1B) for the first source RS, and may carry a second indicator indicating a second trigger state (e.g., 2A or 2B) for the second source RS. The WTRU may determine the first source RS and the second source RS of the TCI state are transmitted by applying the configurations associated with indicated source RS trigger states, respectively.

The following examples may be based on the TCI state level approach source RS trigger state configuration. In one example embodiment, the WTRU may be configured with a TCI state via a TCI state configuration. The TCI state configuration carrying a TCI state ID. The TCI state configuration configures a source RS trigger state A and a source RS trigger state B. The WTRU may be further indicated, via a MAC CE or a DCI, which of the source RS trigger state is applied. For example, while receiving a MAC CE indicating the TCI state switching from de-active to active status, the MAC CE may also carry an indicator indicating one or more trigger state ID(s). Based on the indicated source RS trigger state, the WTRU may determine at least a source RS of the TCI state is transmitted.

For example, the WTRU may determine at least the source RS of the TCI state is transmitted for a specific QCL property estimation which indicated by a QCL type indicator associated with the indicated source RS trigger state.

For example, the WTRU may determine at least the source RS of the TCI state is transmitted with a specific time-domain property which derived based on a time-domain property configuration associated with the indicated source RS trigger state.

For example, the WTRU may determine at least the source RS of the TCI state is transmitted with a specific port pattern which derived based on a Port Pattern configuration associated with the indicated source RS trigger state.

It is noted that the WTRU may determine the source RS is transmitted based on a source RS trigger state after the transmission a HARQ-ACK feedback in response to receiving a DCI indicating the source RS trigger state.

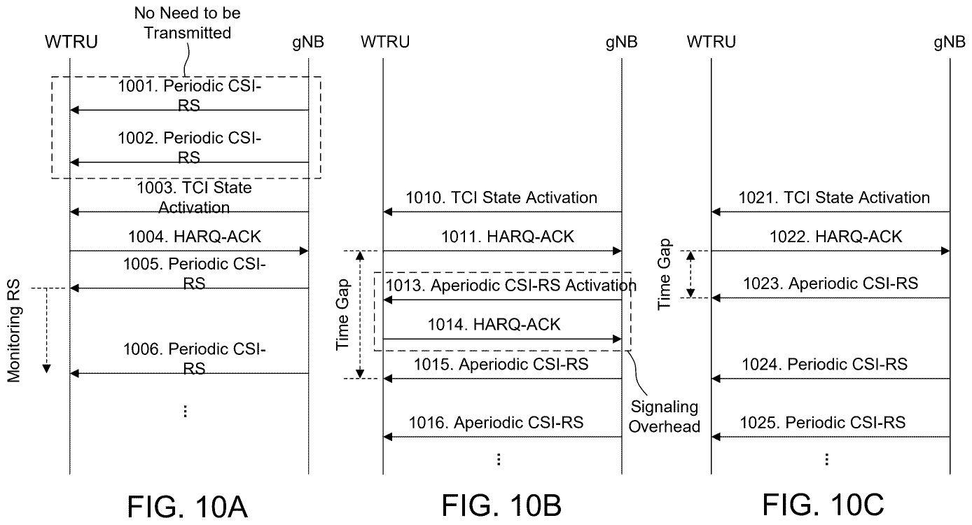

Some embodiments may include RS transmission for a TCI state as a function of (e.g., based on) QCL type and time-domain properties. FIG. 11 illustrates an example diagram depicting first and second TCI statuses showing corresponding RS on/off, according to certain embodiments. For example, a WTRU may be configured with, for a TCI state, two source RSs for QCL-D, and may be configured with a source RS for QCL-A. The WTRU may determine the one of the two source RSs for QCL-D is activated when the TCI state is in semi-active status, and another source RS for QCL-D is activated when the TCI state is in active status.

According to an embodiment, a WTRU may receive a TCI state configuration (e.g., TCI state configuration information), from a network node (e.g., gNB). The TCI state configuration may indicate a TCI state and/or a time-domain property configuration.

In certain embodiments, the TCI state may be associated with a first source RS, a second source RS, and/or a third source RS.

The first source RS may be configured by a first source RS configuration (e.g., first source RS configuration information) for a first type of QCL property estimation indicated by a first QCL type indicator. The first source RS may be applied for a first TCI status indicated by a first associated TCI status indicator (ATSI), where the first QCL type indicator and the first ATSI may be carried by the first source RS configuration.

The second source RS may be configured by a second source RS configuration (e.g., second source RS configuration information) for the first type of QCL property estimation indicated by a second QCL type indicator. The second source RS may be applied for a second TCI status indicated by a second ATSI, where the second QCL type indicator and the second ATSI may be carried by the second source RS configuration.

The third source RS may be configured by a third source RS configuration (e.g., third source RS configuration information) for a second type of QCL property estimation indicated by a third QCL type indicator. The third source RS may be applied for a second TCI status indicated by a third ATSI, where the third QCL type indicator and the third ATSI may be carried by the third source RS configuration.

In an embodiment, the time-domain property configuration may indicate the first, second and/or third source RSs are of a semi-persistent type.

According to certain embodiments, the WTRU may receive, from the network (e.g., gNB), a transmission or information, such as a MAC CE, switching (e.g., indicating to switch) the TCI state to the first TCI status (e.g., semi-active status).

In some embodiments, the WTRU may determine that the first source RS is activated based on the received transmission or information (e.g., the MAC CE). In certain embodiments, the WTRU may perform measurement(s) on the first source RS and/or may report the measurement result(s) to the network (e.g., gNB).

According to some embodiments, the WTRU may receive, from the network (e.g., gNB), an indication or information (e.g., via a first DCI) to switch the TCI state to the second TCI status (e.g., active status).

Based on the indication (e.g., first DCI), the WTRU may determine that the first source RS is not activated, and/or that the second source RS and the third source RS are activated.

In an embodiment, the WTRU may receive an indication or information (e.g., a second DCI) indication downlink reception (e.g., PDSCH reception) by the TCI state.

According to an embodiment, the WTRU may receive the downlink transmission (e.g., PDSCH transmission) based on the activated RS(s), e.g., the second source RS and the third source RS in this example.

Some embodiments may include or provide for the RS of a TCI state being transmitted in different periodicities. For example, in an embodiment, periodic RSs, e.g., SSBs or CSI-RS, may be configured with multiple periodicities, e.g., a long (legacy) periodicity and a short (new) periodicity. Long periodicities can be beneficial, e.g., for RS overhead and network energy saving. An advantage and/or purpose of this embodiment is to turn on the shorter RS periodicity only when it is needed, e.g., when a TCI state comprising the RS is semi-activated/activated.

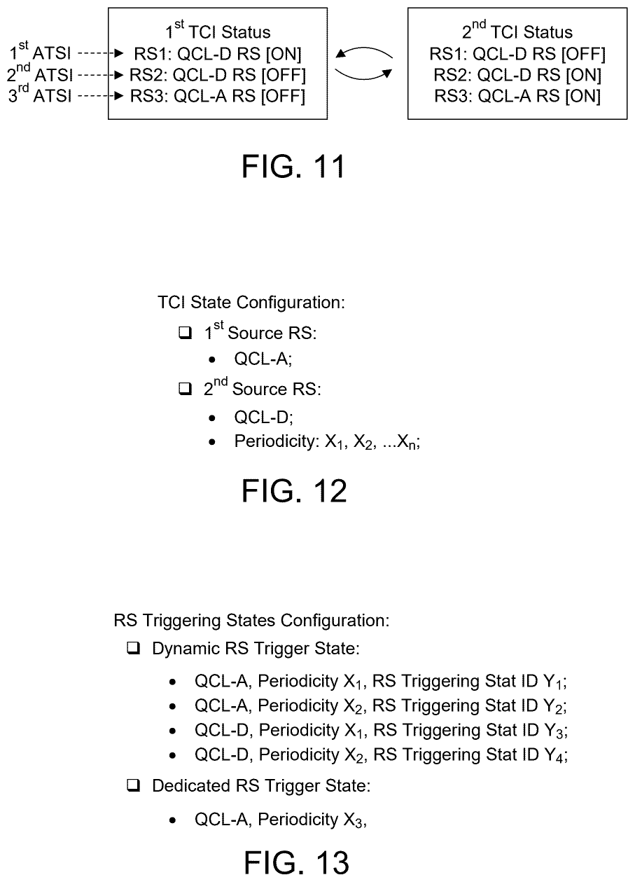

According to an embodiment, a RS of a TCI state may be transmitted in different periodicities determined as a function of (e.g., based on) TCI state status and/or a periodicity indicator. FIG. 12 illustrates an example of TCI state configuration with different periodicity, according to an embodiment. As one example, there may be one transmission periodicity for semi-active status and another transmission periodicity for active status. A periodicity may be carried in MAC CE or DCI to indicate one of multiple configured periodicities.

In certain embodiments, a WTRU may receive a configuration (e.g., RRC configuration information) from a network (e.g., gNB). The configuration (e.g., RRC configuration information) may include or indicate a TCI state configuration (e.g., TCI state configuration information) and a periodicity configuration (e.g., periodicity configuration information). The TCI state configuration (e.g., TCI state configuration information) may indicate (i) a first source RS for QCL type A property estimation and/or (ii) a second source RS for QCL type D property estimation. The periodicity configuration may be associated with the second source RS, where the periodicity configuration indicates (i) a first (long) transmission periodicity and/or (ii) multiple second (short) transmission periodicities.

According to an embodiment, the WTRU may receive, e.g., from the network (e.g., gNB), a transmission or information (e.g., first MAC CE) switching (e.g., indicating to switch) the TCI state to a first TCI status (e.g., semi-active status). The WTRU may determine the second source RS is activated using the first transmission periodicity. The WTRU may perform corresponding measurement(s) and may report the measurement result(s) to the network (e.g., gNB). The WTRU may receive (e.g., from the network/gNB), an indication or information (e.g., via a first DCI) to switch the TCI state to a second TCI status (e.g., active status), where the indication (e.g., first DCI) indicates one of the multiple second transmission periodicities. The WTRU may determine the first source RS is activated (e.g., based on the received information/first DCI). The WTRU may determine the second source RS is activated using the indicated second transmission periodicities. The WTRU may perform corresponding measurement(s) and may report the measurement result(s) to the network (e.g., gNB). In an embodiment, the WTRU may receive an indication or information (e.g., via a second DCI) indicating downlink reception (e.g., a PDSCH reception) based on the TCI state. The WTRU may receive the downlink transmission (e.g., PDSCH transmission) based on the activated source RS(s), e.g., based on the first source RS and the second source RS in this example.

Example embodiments discussed above and elsewhere herein provide several benefits and/or advantages. For example, transmission periodicity of specific QCL type source RS may be dynamically adjusted by the network (e.g., gNB) and indicated, e.g., implicitly through TCI status switching, to WTRU. RS overhead may be reduced by transmitted in longer periodicity when corresponding TCI state is not in active status. Periodicity adjustments is done by L1/L2 signaling which saves delay compared to RRC reconfiguration.

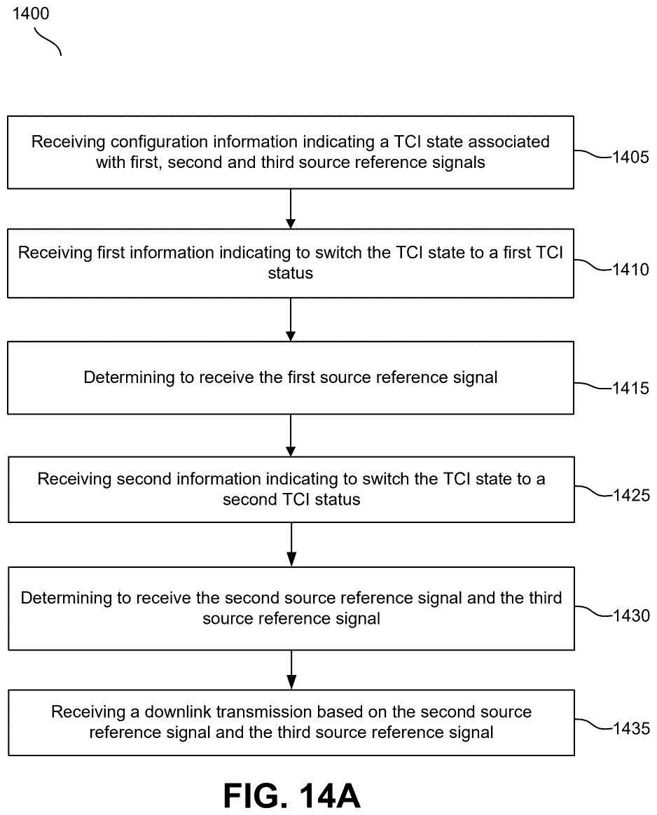

Some embodiments may include or provide for dynamically indicating RS trigger state and/or transmission port. For example, an embodiment may include dynamic QCL type, RS and/or periodicity switching for a TCI state, via L3 pre-configuration and/or L2/L1 signalling. For instance, RRC may pre-configure a dedicated RS trigger state and multiple RS trigger states for a TCI state, where each RS trigger state may indicate a combination of QCL type, RS and/or periodicity. FIG. 13 illustrates an example of RS triggering states configuration, according to an embodiment. Which RS trigger state is applied may be determined based on TCI status and/or L2/L1 signaling.

According to certain embodiments, a WTRU may receive a configuration (e.g., RRC configuration information) from a network (e.g., gNB). The configuration (e.g., RRC configuration information) may include or may indicate multiple source RS trigger state configuration (e.g., more than on source RS trigger state configuration information) and/or a dedicated source RS trigger state. The multiple source RS trigger state configuration information may each indicate multiple dynamic source RS trigger states. The multiple dynamic source RS trigger states are each associated with a trigger state ID, a first time-domain property configuration, and/or a first port pattern (configuration). The first time-domain property configuration indicates the combination of: (i) one of multiple types of QCL property (e.g., type A, B, C or D), and/or (ii) one of multiple transmission periodicities (e.g., long or short periodicity)/offsets. The dedicated source RS trigger state is associated with a second time-domain property configuration indicating the combination of: a second type of QCL property, a second transmission periodicity/offset, and/or a second port pattern configuration.

In an embodiment, the WTRU may receive (e.g., from the network/gNB), an indication or information (e.g., via a first MAC CE) switching (e.g., indicating to switch) the TCI state to a first TCI status (e.g., semi-active status), and the information (e.g., included in the first MAC CE) may further indicates: one of the trigger state IDs.

In an embodiment, the WTRU may determine the source RS is transmitted in a first pattern based on the indicated one of the trigger state IDs, and/or may perform corresponding measurement(s). If performed or if needed, the WTRU may report the measurement result(s) to the network (e.g., gNB).

In an embodiment, the WTRU may receive (e.g., from the network/gNB), an indication or information (e.g., a DCI) to switch the TCI state to a second TCI status (e.g., active status). The WTRU may determine the source RS is transmitted in a second pattern based the dedicated source RS trigger state and/or may perform corresponding measurement(s). If performed or if needed, the WTRU may report the measurement result(s) to the network (e.g., gNB).

Example embodiments discussed above and elsewhere herein provide several benefits and/or advantages. For example, overhead of RS for QCL type-A and QCL type-D of a TCI state is reduced when the TCI state is semi-activated (e.g., where RS for QCL type-A is transmitted in long periodicity; RS for QCL type-D is not transmitted. Instead, WTRU refers to RS of an anchor TCI state). Additionally, the signaling overhead on (de)activation RS transmission is avoided since the (de)activation RS transmission is linked to corresponding TCI state status switching (thereby saving delay as well). Further, the network (e.g., gNB) can dynamically decide which anchor state is for specific QCL-type.

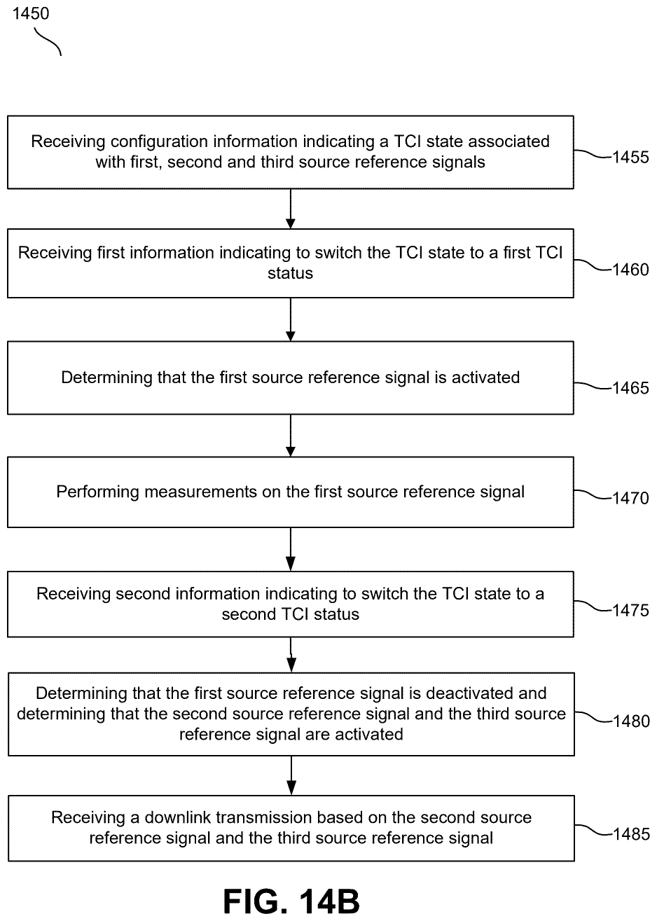

FIG. 14A illustrates an example flow diagram of a method 1400 for or relating to reducing RS overhead, e.g., in near field, according to some embodiments. The example method 1400 of FIG. 14A and accompanying disclosures herein may include, may be based on, or may be a synthesization of various embodiments or elements discussed in detail above.

For convenience and simplicity of exposition, the example of FIG. 14A may be described with reference to the architecture or system described above with respect to FIGS. 1A-1D, for instance. However, the example method 1400 depicted in FIG. 14A may be carried out using different architectures as well. According to some embodiments, the method 1400 of FIG. 14A may be performed or implemented by a UE or WTRU, such as the WTRU 102 described in the foregoing or the WTRU illustrated in the examples of FIGS. 10A-10C.

It is noted that the method 1400 of FIG. 14A may include further steps, procedures or details as discussed in detail elsewhere in this disclosure. As such, the method 1400 of FIG. 14A may be modified to include any of the steps, procedures, elements and/or details illustrated and/or discussed in the foregoing or the following.

Moreover, it is noted that the method and/or blocks of FIG. 14A may be modified to include, or to be replaced by, any one or more of the procedures, elements or blocks discussed elsewhere herein. As such, one of ordinary skill in the art would understand that FIG. 14A is provided as one example and modifications thereto are possible while remaining within the scope of certain example embodiments.

As illustrated in the example of FIG. 14A, the method 1400 may include, at 1405, receiving configuration information including or indicating a transmission configuration indication (TCI) state. The TCI state is associated with: (1) a first source reference signal associated with a first quasi co-location (QCL) type for a first TCI status, (2) a second source reference signal associated with the first QCL type for a second TCI status, and (3) a third source reference signal associated with a second QCL type.

In some embodiments, the third source reference signal may be associated with the first QCL type for the second TCI status.

For example, the first TCI status may be a semi-active status and the second TCI status may be an active status. For example, the first QCL type may be QCL type D and the second QCL type may be QCL type A.

In some embodiments, the method 1400 may include, at 1410, receiving first information indicating to switch the TCI state to the first TCI status. According to one example, the first information is, or may be included in, a medium access control (MAC) control element (CE).

According to some embodiments, the method 1400 may include, at 1415, based on the first information, determining to receive the first source reference signal (e.g., the WTRU may determine to receive the first source RS since the WTRU knows or determines the first source RS is activated based on the first RS association with the first TCI state). In some examples, the first source reference signal may be used and/or applied for QCL property estimation, for parameter estimation, and/or for other purposes suitable for a source RS (e.g., as discussed elsewhere herein).

In an embodiment, the method 1400 might include (though not shown in the example FIG. 14A) performing measurements on the first source reference signal.

According to some embodiments, the method 1400 may include, at 1425, receiving second information indicating to switch the TCI state to the second TCI status. In one example, the second information is, or may be included in, a first downlink control information (DCI).

In some embodiments, the method 1400 may include, at 1430, based on the second information, determining to receive the second source reference signal and/or the third source reference signal (e.g., the WTRU may determine to receive the second and third source RSs since the WTRU can determine that the first source RS is deactivated and that the second and the third source RSs are activated, based on the switch to the second TCI status that is associated with the second and third source reference signals). In some examples, the second and third source reference signals may be used and/or applied for QCL property estimation, for parameter estimation, and/or for other purposes suitable for a source RS (e.g., as discussed elsewhere herein).

According to some embodiments, the method 1400 may include, at 1435, receiving a downlink transmission based on the second source reference signal and the third source reference signal (e.g., based on the received and/or activated reference signals).

In some embodiments, the configuration information received at 1405 may include or indicate time-domain property configuration information indicating the first source reference signal, the second source reference signal, and the third source reference signal are of a semi-persistent type.

According to some embodiments, the method 1400 may include (though not shown in FIG. 14A) reporting, to a network node, a result of the measurements performed on the first source reference signal.

In some embodiments, the configuration information may include an indicator, such as an associated TCI status indicator (ATSI), to indicate that the first, second and/or third source reference signals are associated with any of the first TCI status and/or the second TCI status.

According to some embodiments, the downlink transmission may be a physical downlink shared channel (PDSCH) transmission. In some embodiments, the method 1400 may include (though not shown in FIG. 14A) receiving third information indicating a physical downlink shared channel (PDSCH) reception based on the TCI state, and receiving the physical downlink shared channel (PDSCH) transmission based on the second source reference signal and the third source reference signal (e.g., based on the active reference signals).

FIG. 14B illustrates an example flow diagram of a method 1450 for or relating to reducing RS overhead, e.g., in near field, according to some embodiments. The example method 1450 of FIG. 14B and accompanying disclosures herein may include, may be based on, or may be a synthesization of various embodiments or elements discussed in detail above.

For convenience and simplicity of exposition, the example of FIG. 14B may be described with reference to the architecture or system described above with respect to FIGS. 1A-1D, for instance. However, the example method 1450 depicted in FIG. 14B may be carried out using different architectures as well. According to some embodiments, the method 1450 of FIG. 14B may be performed or implemented by a UE or WTRU, such as the WTRU 102 described in the foregoing or the WTRU illustrated in the examples of FIGS. 10A-10C.

It is noted that the method 1450 of FIG. 14B may include further steps, procedures or details as discussed in detail elsewhere in this disclosure. As such, the method 1450 of FIG. 14B may be modified to include any of the steps, procedures, elements and/or details illustrated and/or discussed in the foregoing.

Moreover, it is noted that the method and/or blocks of FIG. 14B may be modified to include, or to be replaced by, any one or more of the procedures, elements or blocks discussed elsewhere herein. As such, one of ordinary skill in the art would understand that FIG. 14B is provided as one example and modifications thereto are possible while remaining within the scope of certain example embodiments.

As illustrated in the example of FIG. 14B, the method 1450 may include, at 1455, receiving configuration information including or indicating a transmission configuration indication (TCI) state. The TCI state is associated with: (1) a first source reference signal associated with a first quasi co-location (QCL) type for a first TCI status, (2) a second source reference signal associated with the first QCL type for a second TCI status, and (3) a third source reference signal associated with a second QCL type.

In some embodiments, the third source reference signal may be associated with the first QCL type for the second TCI status.

For example, the first TCI status may be a semi-active status and the second TCI status may be an active status. For example, the first QCL type may be QCL type D and the second QCL type may be QCL type A.

In some embodiments, the method 1450 may include, at 1460, receiving first information indicating to switch the TCI state to the first TCI status. According to one example, the first information is, or may be included in, a medium access control (MAC) control element (CE).

According to some embodiments, the method 1450 may include, at 1465, based on the first information, determining that the first source reference signal is activated (e.g., the WTRU may determine to receive the first source reference signal, for example, to use for QCL property or parameter estimation or for other purposes). In an embodiment, the method 1450 may include, at 1470, performing measurements on the first source reference signal.

According to some embodiments, the method 1450 may include, at 1475, receiving second information indicating to switch the TCI state to the second TCI status. In one example, the second information is, or may be included in, a first downlink control information (DCI).

In some embodiments, the method 1450 may include, at 1480, based on the second information, determining that the first source reference signal is deactivated and/or determining that the second source reference signal and the third source reference signal are activated (e.g., the WTRU may determine to receive the second and third source reference signal, for example, to use for QCL property or parameter estimation or for other purposes).

According to some embodiments, the method 1450 may include, at 1485, receiving a downlink transmission based on the second source reference signal and the third source reference signal (e.g., based on the activated or received reference signals).

In some embodiments, the configuration information received at 1455 may include or indicate time-domain property configuration information indicating the first source reference signal, the second source reference signal, and the third source reference signal are of a semi-persistent type.

According to some embodiments, the method 1450 may include (though not shown in FIG. 14) reporting, to a network node, a result of the measurements performed on the first source reference signal.

In some embodiments, the configuration information may include an indicator, such as an associated TCI status indicator (ATSI), to indicate that the first, second and/or third source reference signals are associated with any of the first TCI status and/or the second TCI status.

According to some embodiments, the downlink transmission may be a physical downlink shared channel (PDSCH) transmission. In some embodiments, the method 1450 may include (though not shown in FIG. 14) receiving third information indicating a physical downlink shared channel (PDSCH) reception based on the TCI state, and receiving the physical downlink shared channel (PDSCH) transmission based on the second source reference signal and the third source reference signal (e.g., based on the active reference signals).

As discussed above, in some embodiments, a source reference signal being determined as activated (or deactivated) by a WTRU may refer to the WTRU determining the source reference signal is transmitted (or not transmitted) by the network (e.g., gNB) or may refer to the WTRU determining the source reference signal is transmitted (not transmitted) by the network (e.g., gNB) on radio resources configured by the source RS configuration. It is noted that, from the network perspective, the source reference signal may be transmitted even if the source reference signal is determined as not transmitted by the WTRU. For example, the determination of the source reference signal being activated (or deactivated) may be based on either an ATSI associated with the source reference signal configuration and/or a TCI status of a TCI state configured by TCI state configuration which is associated with the source reference signal configuration.

As also discussed above, in some embodiments, a source reference signal being determined as activated (or deactivated) by a WTRU may refer to the WTRU determining the source reference signal configuration (associated with the source reference signal) is activated (or deactivated) by the network (e.g., gNB). For example, the source reference signal configuration may be activated (or deactivated) by the network (e.g., gNB) through any of L2 (e.g., MAC layer) and/or L1 signaling (e.g., PHY layer). It is noted that, from the network perspective, the source refence signal may be transmitted by the network (e.g., gNB) even if the source reference signal configuration is determined as deactivated by the WTRU.

As also discussed above, in some embodiments, a source reference being determined as activated (or deactivated) by a WTRU may refer to the WTRU determining the source reference signal is needed (or not needed) to be received (or monitored) by the WTRU. For example, a source reference signal being determined as activated (or deactivated) by a WTRU may refer to the WTRU determining the source reference signal is needed (or not needed) to be received (or monitored) by the WTRU for a type of QCL property estimation that may be configured by a QCL Type Indicator associated with the source reference signal configuration.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

1. A wireless transmit/receive unit (WTRU), comprising:
circuitry, including any of a processor and transceiver, configured to:
receive configuration information indicating a transmission configuration indication (TCI) state, wherein the TCI state is associated with (1) a first source reference signal associated with a first quasi co-location (QCL) type for a first TCI status, (2) a second source reference signal associated with the first QCL type for a second TCI status, and (3) a third source reference signal associated with a second QCL type;
receive first information indicating to switch the TCI state to the first TCI status;
based on the first information, determine to receive the first source reference signal;
perform measurements on the first source reference signal;
receive second information indicating to switch the TCI state to the second TCI status;
based on the second information, determine to receive the second source reference signal and the third source reference signal; and
receive a downlink transmission based on the second source reference signal and the third source reference signal.

2. The WTRU of claim 1, wherein the configuration information comprises time-domain property configuration information indicating the first source reference signal, the second source reference signal, and the third source reference signal are of a semi-persistent type.

3. The WTRU of claim 1, wherein the first QCL type comprises QCL type D and the second QCL type comprises QCL type A.

4. The WTRU of claim 1, wherein the first TCI status comprises a semi-active status and the second TCI status comprises an active status.

5. The WTRU of claim 1, wherein the third source reference signal is associated with the first QCL type for the second TCI status.

6. The WTRU of claim 1, configured to:
report, to a network node, a result of the measurements performed on the first source reference signal.

7. The WTRU of claim 1, wherein the first information is, or is included in, a medium access control (MAC) control element (CE).

8. The WTRU of claim 1, wherein the second information is, or is included in, a first downlink control information (DCI).

9. The WTRU of claim 1, wherein the downlink transmission comprises a physical downlink shared channel (PDSCH) transmission; and
wherein the WTRU is configured to:
receive third information indicating a physical downlink shared channel (PDSCH) reception based on the TCI state; and
receive the physical downlink shared channel (PDSCH) transmission based on the second source reference signal and the third source reference signal.

10. The WTRU of claim 1, wherein the configuration information comprises an associated TCI status indicator (ATSI) to indicate that the first, second and third source reference signals are associated with any of the first TCI status and the second TCI status.

11. A method, implemented by a wireless transmit/receive unit (WTRU), the method comprising:
receiving configuration information indicating a transmission configuration indication (TCI) state, wherein the TCI state is associated with (1) a first source reference signal associated with a first quasi co-location (QCL) type for a first TCI status, (2) a second source reference signal associated with the first QCL type for a second TCI status, and (3) a third source reference signal associated with a second QCL type;
receiving first information indicating to switch the TCI state to the first TCI status;
based on the first information, determining to receive the first source reference signal;
performing measurements on the first source reference signal;
receiving second information indicating to switch the TCI state to the second TCI status;
based on the second information, determining to receive the second source reference signal and the third source reference signal; and
receiving a downlink transmission based on the second source reference signal and the third source reference signal.

12. The method of claim 11, wherein the configuration information comprises time-domain property configuration information indicating the first source reference signal, the second source reference signal, and the third source reference signal are of a semi-persistent type.

13. The method of claim 11, wherein the first QCL type comprises QCL type D and the second QCL type comprises QCL type A.

14. The method of claim 11, wherein the first TCI status comprises a semi-active status and the second TCI status comprises an active status.

15. The method of claim 11, wherein the third source reference signal is associated with the first QCL type for the second TCI status.

16. The method of claim 11, comprising:
reporting, to a network node, a result of the measurements performed on the first source reference signal.

17. The method of claim 11, wherein the first information is, or is included in, a medium access control (MAC) control element (CE).

18. The method of claim 11, wherein the second information is, or is included in, a first downlink control information (DCI).

19. The method of claim 11, wherein the downlink transmission comprises a physical downlink shared channel (PDSCH) transmission; and
wherein the method comprises:
receiving third information indicating a physical downlink shared channel (PDSCH) reception based on the TCI state; and
receiving the physical downlink shared channel (PDSCH) transmission based on the second source reference signal and the third source reference signal.

20. The method of claim 11, wherein the configuration information comprises an associated TCI status indicator (ATSI) to indicate that the first, second and third source reference signals are associated with any of the first TCI status and the second TCI status.
